(19) United States
(12) Patent Application Publication
(10) Pub. No.: US 2026/0288188 A1
(43) Pub. Date: Sep. 24, 2026

(54) SEMICONDUCTOR INTEGRATED CIRCUIT

(71) Applicants: KABUSHIKI KAISHA TOSHIBA, Kawasaki-shi (JP); TOSHIBA ELECTRONIC DEVICES & STORAGE CORPORATION, Kawasaki-shi (JP)

(72) Inventor: Katsuyuki IKEUCHI, Yokohama (JP)

(73) Assignees: KABUSHIKI KAISHA TOSHIBA, Kawasaki-shi (JP); TOSHIBA ELECTRONIC DEVICES & STORAGE CORPORATION, Kawasaki-shi (JP)

(21) Appl. No.: 19/311,070

(22) Filed: Aug. 27, 2025

(30) Foreign Application Priority Data
Mar. 24, 2025 (JP) 2025-048028

(51) Int. Cl. G05F 3/26

(52) U.S. Cl. CPC G05F 3/262

(57) ABSTRACT

According to one embodiment, in a semiconductor integrated circuit, a first transistor has a base connected to an output node. A second transistor has a base connected to the output node, whose size is different from the first transistor. A first resistance element is connected between an emitter of the first transistor and an emitter of the second transistor. A second resistance element is connected between the emitter of the second transistor and a reference node. A first compensation circuit extracts a first current from a first node between the emitter of the first transistor and the first resistance element, the first current being equivalent to a base current of the first transistor. A second compensation circuit extracts a second current from a second node between the emitter of the second transistor and the second resistance element, the second current being equivalent to a base current of the second transistor.

### CROSS-REFERENCE TO RELATED APPLICATIONS

This application is based upon and claims the benefit of priority from Japanese Patent Application No. 2025-048028, filed on Mar. 24, 2025; the entire contents of which are incorporated herein by reference.

### FIELD

Embodiments described herein relate generally to a semiconductor integrated circuit.

### BACKGROUND

In a semiconductor integrated circuit, a constant voltage to be a reference voltage may be generated using a transistor. In the semiconductor integrated circuit, it is desired to stably generate a constant voltage.

### BRIEF DESCRIPTION OF THE DRAWINGS

FIG. 1 is a block diagram illustrating a schematic configuration of a semiconductor integrated circuit according to a first embodiment;

FIG. 2 is a circuit diagram illustrating a schematic configuration of a constant voltage generation circuit according to the first embodiment;

FIG. 3 is a circuit diagram illustrating a detailed configuration of the constant voltage generation circuit according to the first embodiment;

FIG. 4 is a diagram illustrating current density dependence of a current amplification factor for each temperature according to the first embodiment;

FIG. 5 is a circuit diagram illustrating a schematic configuration of a constant voltage generation circuit in a first modification of the first embodiment;

FIG. 6 is a circuit diagram illustrating a detailed configuration of the constant voltage generation circuit in the first modification of the first embodiment;

FIG. 7 is a circuit diagram illustrating a schematic configuration of a constant voltage generation circuit in a second modification of the first embodiment;

FIG. 8 is a circuit diagram illustrating a detailed configuration of the constant voltage generation circuit in the second modification of the first embodiment;

FIG. 9 is a circuit diagram illustrating a schematic configuration of a constant voltage generation circuit according to a second embodiment;

FIG. 10 is a circuit diagram illustrating a detailed configuration of the constant voltage generation circuit according to the second embodiment;

FIG. 11 is a circuit diagram illustrating a schematic configuration of a constant voltage generation circuit in a first modification of the second embodiment;

FIG. 12 is a circuit diagram illustrating a detailed configuration of the constant voltage generation circuit in the first modification of the second embodiment;

FIG. 13 is a circuit diagram illustrating a schematic configuration of a constant voltage generation circuit in a second modification of the second embodiment;

FIG. 14 is a circuit diagram illustrating a detailed configuration of the constant voltage generation circuit in the second modification of the second embodiment;

FIG. 15 is a circuit diagram illustrating a schematic configuration of a constant voltage generation circuit according to a third embodiment;

FIG. 16 is a circuit diagram illustrating a detailed configuration of the constant voltage generation circuit according to the third embodiment;

FIG. 17 is a circuit diagram illustrating a schematic configuration of a constant voltage generation circuit in a first modification of the third embodiment;

FIG. 18 is a circuit diagram illustrating a detailed configuration of the constant voltage generation circuit in the first modification of the third embodiment;

FIG. 19 is a circuit diagram illustrating a schematic configuration of a constant voltage generation circuit in a second modification of the third embodiment; and

FIG. 20 is a circuit diagram illustrating a detailed configuration of the constant voltage generation circuit in the second modification of the third embodiment.

### DETAILED DESCRIPTION

In general, according to one embodiment, there is provided a semiconductor integrated circuit including a first transistor, a second transistor, a first resistance element, a second resistance element, a first compensation circuit, and a second compensation circuit. The first transistor has a base connected to an output node. The second transistor has a base connected to the output node, the second transistor being different in size from the first transistor. The first resistance element is connected between an emitter of the first transistor and an emitter of the second transistor. The second resistance element is connected between the emitter of the second transistor and a reference node. The first compensation circuit extracts a first current from a first node between the emitter of the first transistor and the first resistance element, the first current being equivalent to a base current of the first transistor. The second compensation circuit extracts a second current from a second node between the emitter of the second transistor and the second resistance element, the second current being equivalent to a base current of the second transistor.

Exemplary embodiments of a semiconductor integrated circuit will be explained below in detail with reference to the accompanying drawings. The present invention is not limited to the following embodiments.

### First Embodiment

The semiconductor integrated circuit according to a first embodiment generates a constant voltage to be a reference voltage using a transistor, and is devised in order to stably generate a constant voltage.

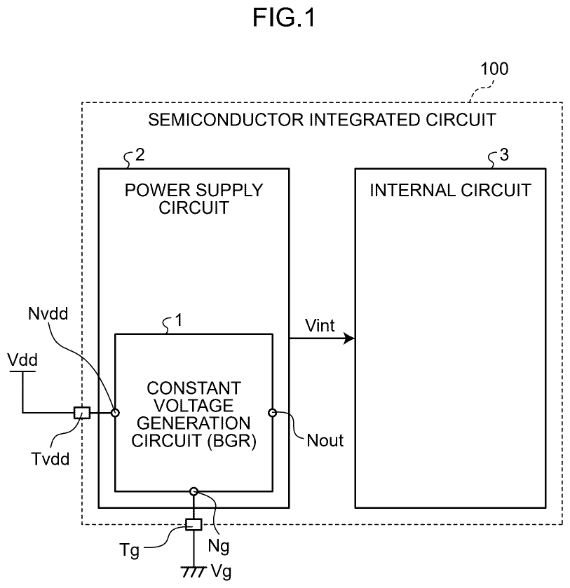

A semiconductor integrated circuit 100 can be configured as illustrated in FIG. 1. FIG. 1 is a circuit diagram illustrating a configuration of the semiconductor integrated circuit 100.

The semiconductor integrated circuit 100 has a power supply terminal Tvdd and a reference terminal Tg. The power supply terminal Tvdd is connected to an external power supply potential Vdd. The reference terminal Tg is connected to an external reference potential (for example, the ground potential) Vg.

The semiconductor integrated circuit 100 includes a constant voltage generation circuit 1. The constant voltage generation circuit 1 has a power supply node Nvdd, a reference node Ng, and an output node Nout. The power supply node Nvdd is connected to an external power supply potential Vdd via the power supply terminal Tvdd, and can receive the power supply potential Vdd from the outside via the power supply terminal Tvdd. The reference node Ng is connected to the external reference potential Vg via the reference terminal Tg, and can receive the reference potential Vg from the outside via the power supply terminal Tvdd.

The constant voltage generation circuit 1 generates a constant voltage Vbgr using the power supply potential Vdd and the reference voltage Vg that have been received. The constant voltage generation circuit 1 includes, for example, a band gap reference (BGR) type voltage generation circuit, and may generate the constant voltage Vbgr according to a band gap of the semiconductor. The constant voltage generation circuit 1 may output the constant voltage Vbgr as a reference voltage from the output node Nout.

The semiconductor integrated circuit 1 may be such that the constant voltage generation circuit 1 alone is mounted on a chip, such that a power supply circuit 2 including the constant voltage generation circuit 1 is mounted on a chip, or such that the power supply circuit 2 including the constant voltage generation circuit 1 and an internal circuit 3 may be mounted on a chip. FIG. 1 illustrates the semiconductor integrated circuit 100 in which the power supply circuit 2 including the constant voltage generation circuit 1 and the internal circuit 3 are mounted on a chip.

The power supply circuit 2 illustrated in FIG. 1 includes the constant voltage generation circuit 1. The power supply circuit 2 can generate an internal power supply voltage Vint using the constant voltage Vbgr generated by the constant voltage generation circuit 1 as a reference voltage. The power supply circuit 2 can supply the internal power supply voltage Vint to the internal circuit 3. As a result, the internal circuit 3 can operate using the internal power supply voltage Vint.

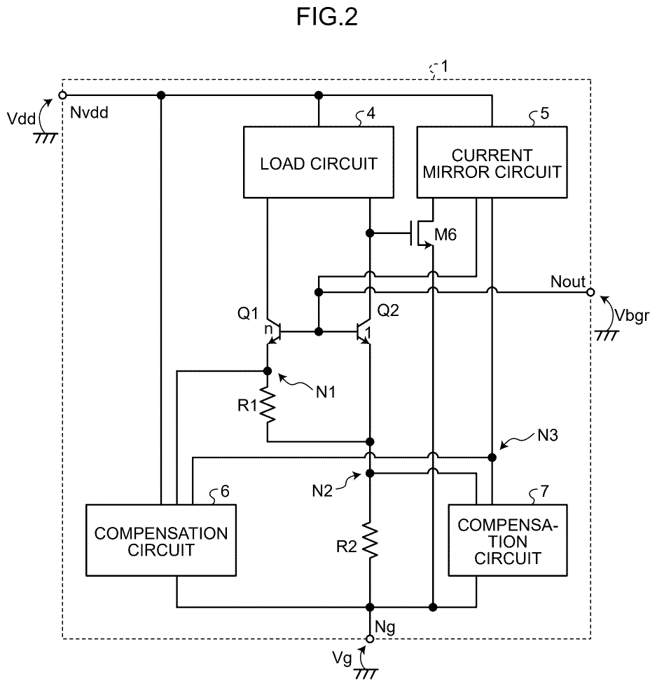

The constant voltage generation circuit 1 can be configured as illustrated in FIG. 2. FIG. 2 is a circuit diagram illustrating a schematic configuration of the constant voltage generation circuit 1.

The constant voltage generation circuit 1 includes a transistor Q1, a transistor Q2, a transistor M6, a resistance element R1, a resistance element R2, a load circuit 4, a current mirror circuit 5, a compensation circuit 6, and a compensation circuit 7.

The transistor Q1 is connected between the transistor Q2, the resistance element R1, the load circuit 4, the current mirror circuit 5, and the compensation circuit 6. The transistor Q1 may be an NPN type bipolar transistor. In the transistor Q1, a collector is connected to the load circuit 4, an emitter is connected to the resistance element R1 and the compensation circuit 6, and a base is connected to the transistor Q2, the current mirror circuit 5, and the output node Nout.

The transistor Q2 is connected between the transistor Q1, the resistance element R1, the load circuit 4, the current mirror circuit 5, and the compensation circuit 7. The transistor Q2 may be an NPN type bipolar transistor. The transistor Q2 has a collector connected to the load circuit 4, an emitter connected to the resistance element R1 and the compensation circuit 7, and a base connected to the transistor Q1, the current mirror circuit 5, and the output node Nout.

A size of the transistor Q1 is n times a size of the transistor Q2. n is any number greater than 1.

The transistor M6 is connected between the transistor Q2, the load circuit 4, and the current mirror circuit 5. The transistor M6 may be an N type field effect transistor. The transistor M6 has a drain connected to the current mirror circuit 5, a gate connected to a node between the load circuit 4 and the transistor Q2, and a source connected to the reference node Ng.

The resistance element R1 is connected between the transistor Q1 and the transistor Q2. In a case where the transistors Q1 and Q2 are NPN type bipolar transistors, the resistance element R1 may be connected between the emitter of the transistor Q1 and the emitter of the transistor Q2. One end of the resistance element R1 is connected to the emitter of the transistor Q1 and to the compensation circuit 6, and the other end is connected to a node between the emitter of the transistor Q2 and the resistance element R2 and to the compensation circuit 6.

The resistance element R2 is connected between the transistor Q2 and the reference node Ng. In a case where the transistor Q2 is an NPN type bipolar transistor, the resistance element R2 may be connected between the emitter of the transistor Q2 and the reference node Ng. One end of the resistance element R2 is connected to the emitter of the transistor Q2, to the other end of the resistance element R1, and to the compensation circuit 7, and the other end is connected to the reference node Ng.

The load circuit 4 is connected between the power supply node Nvdd and the transistors Q1 and Q2. In a case where the transistors Q1 and Q2 are NPN type bipolar transistors, the load circuit 4 is connected between the power supply node Nvdd, and the collector of the transistor Q1 and the collector of the transistor Q2.

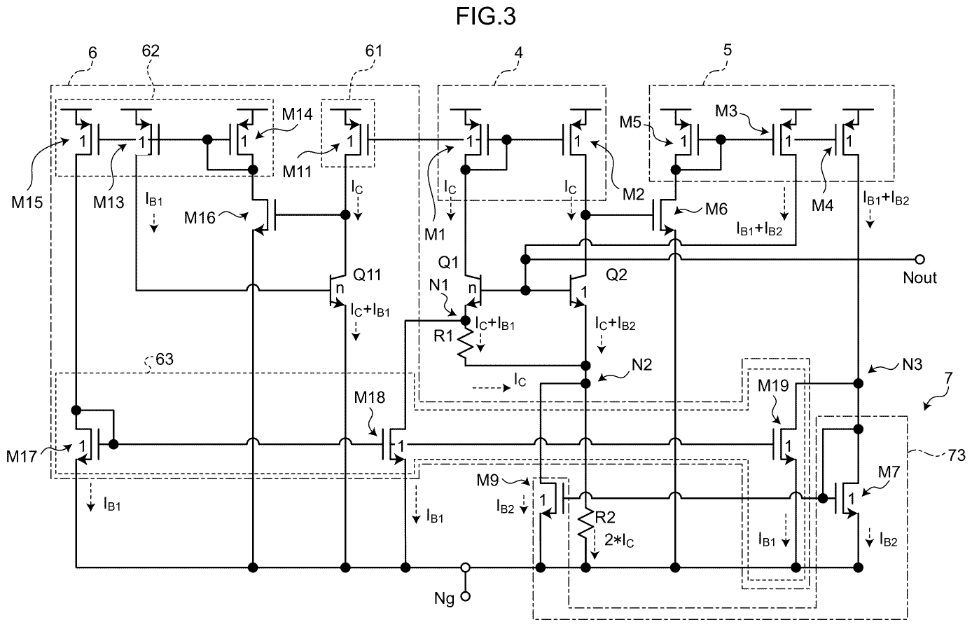

The load circuit 4 can be configured as illustrated in FIG. 3. FIG. 3 is a circuit diagram illustrating a detailed configuration of the constant voltage generation circuit 1.

The load circuit 4 includes a transistor M1 and a transistor M2. The transistor M1 is connected between the power supply node Nvdd and the transistor Q1. The transistor M2 is connected between the power supply node Nvdd and the transistor Q2. In a case where the transistors Q1 and Q2 are NPN type bipolar transistors, the transistor M1 is connected between the power supply node Nvdd and the collector of the transistor Q1. The transistor M2 is connected between the power supply node Nvdd and the transistor Q2.

The transistor M1 and the transistor M2 are connected in current mirror connection. In a case where the transistors M1 and M2 are P type field effect transistors, the transistor M1 has a source connected to the power supply node Nvdd, and a gate and a drain connected to a gate of the transistor M2 and the transistor Q2, respectively. The transistor M2 has a source connected to the power supply node Nvdd, a drain connected to the transistor Q2, and a gate connected to the gate of the transistor M1.

The load circuit 4 supplies equivalent currents to the transistor Q1 and the transistor Q2. In a case where the transistors Q1 and Q2 are NPN type bipolar transistors, the load circuit 4 supplies equivalent currents to the collector of the transistor Q1 and the collector of the transistor Q2.

Here, since the size of the transistor Q1 is n times the size of the transistor Q2, a current density Jc1 of the transistor Q1 is different from a current density Jc2 of the transistor Q2 by about 1/n times. Accordingly, a base-emitter voltage of the transistor Q1 and a base-emitter voltage of the transistor Q2 are different from each other.

On the other hand, by connecting the resistance element R1 between the emitter of the transistor Q1 and the emitter of the transistor Q2, when a current flows through the resistance element R1, a voltage corresponding to a difference between the base-emitter voltages of the transistors Q1 and Q2 can be generated at both ends of the resistance element R1.

In addition, when the environmental temperature fluctuates, temperature fluctuations respectively of the base-emitter voltages of the transistors Q1 and Q2 may occur. For example, each of the base-emitter voltages of the transistors Q1 and Q2 may change with a negative increasing function with respect to temperature.

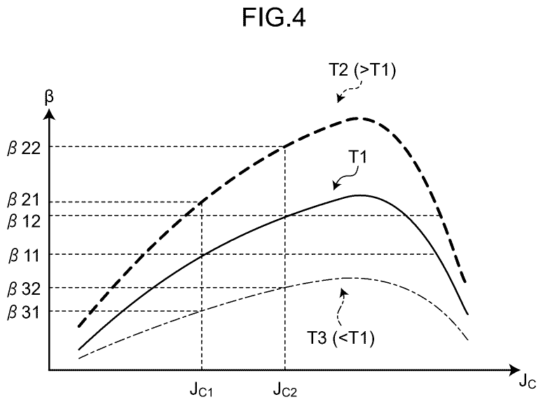

On the other hand, current amplification factors β of the transistors Q1 and Q2 have current density dependence and temperature dependence as illustrated in FIG. 4. FIG. 4 is a diagram illustrating the current density dependence of the current amplification factors β for each temperature. In FIG. 4, the current density dependence of the current amplification factors β at temperature T1 is indicated by a solid line, the current density dependence of the current amplification factors β at temperature T2 (>T1) is indicated by a dotted line, and the current density dependence of the current amplification factors β at temperature T3 (<T1) is indicated by a dash-dot line.

In response to the fact that a current density Jc1 of the transistor Q1 and a current density Jc2 of the transistor Q2 are different from each other, the current amplification factor β of the transistor Q1 and the current amplification factor β of the transistor Q2 have different values for each temperature T as illustrated in FIG. 4.

In a case where the current environmental temperature is T1, the current density dependence of the current amplification factor β changes as indicated by the solid line. In the transistor Q1, the current amplification factor becomes β11 according to the current density being Jc1. In the transistor Q2, the current amplification factor becomes β12 (>β11) according to the current density being Jc2 (>Jc1).

In a case where the current environmental temperature is T2, the current density dependence of the current amplification factor β changes as indicated by the dotted line. In the transistor Q1, the current amplification factor becomes β21 (>β11) according to the current density being Jc1. In the transistor Q2, the current amplification factor becomes β22 (>β21, >β12) according to the current density being Jc2 (>Jc1).

In a case where the current environmental temperature is T3, the current density dependence of the current amplification factor β changes as indicated by the dash-dot line. In the transistor Q1, the current amplification factor becomes β31 (<β11) according to the current density being Jc1. In the transistor Q2, the current amplification factor becomes β32 (>β31, <β12) according to the current density being Jc2 (>Jc1).

That is, each of the current amplification factors of the transistors Q1 and Q2 may change with a positive increasing function with respect to temperature. Accordingly, each of emitter currents of the transistors Q1 and Q2 may change with a positive increasing function with respect to temperature.

Therefore, by connecting the resistance element R2 between the emitters of the transistors Q1 and Q2 and the reference node Ng, the voltage across terminals of the resistance element R2 can change with a positive increasing function with respect to temperature. As a result, it is expected that an influence of the temperature dependence of the base-emitter voltages of the transistors Q1 and Q2 that can change with a negative increasing function with respect to the temperature can be reduced by the temperature dependence of the voltage across the terminals of the resistance element R2.

However, among collector currents and the base currents included in the emitter currents of the transistors Q1 and Q2, the temperature change characteristic of the collector current can change symmetrically with respect to the temperature change characteristic of the base-emitter voltage, whereas the temperature change characteristic of the base current can change asymmetrically with respect to the temperature change characteristic of the base-emitter voltage. Therefore, when the base currents of the transistors Q1 and Q2 flow through the resistance element R2, there is a possibility that the temperature dependence cannot be reduced.

On the other hand, in the constant voltage generation circuit 1, the compensation circuit 6, the current mirror circuit 5, and the compensation circuit 7 are provided, and the base current I_{B1} is extracted from a node N1 and the base current I_{B2} is extracted from a node N2. The node N1 is disposed between the transistor Q1 and the resistance element R1. The node N2 is disposed between the transistor Q2 and the resistance element R2.

The compensation circuit 6 is connected between the power supply node Nvdd, the node N1, a node N3, and the reference node Ng. The compensation circuit 6 generates a current I_{B1} corresponding to the base current I_{B1} of the transistor Q1, and extracts the current I_{B1} from the nodes N1 and N3.

As illustrated in FIG. 3, the compensation circuit 6 includes a load circuit 61, a replica transistor Q11, a current mirror circuit 62, and a current mirror circuit 63.

The load circuit 61 is connected between the power supply node Nvdd and the replica transistor Q11. In a case where the replica transistor Q11 is an NPN type bipolar transistor, the load circuit 4 is connected between the power supply node Nvdd and the collector of the transistor Q1 and the collector of the transistor Q2.

The load circuit 61 includes a transistor M11. The transistor M11 is connected between the power supply node Nvdd and the replica transistor Q11. In a case where the replica transistor Q11 is an NPN type bipolar transistor, the transistor M1 is connected between the power supply node Nvdd and a collector of the replica transistor Q11.

The replica transistor Q11 is connected between the transistor Q2, the load circuit 61, the current mirror circuit 62, and the reference node Ng. The replica transistor Q11 may be an NPN type bipolar transistor. The replica transistor Q11 has the collector connected to the load circuit 61, an emitter connected to the reference node Ng, and a base connected to the current mirror circuit 62.

The replica transistor Q11 is provided as a replica of the transistor Q1. A size of the replica transistor Q11 is substantially equal to a size of the transistor Q1. As a result, a current I_{B1} corresponding to the base current I_{B1} of the transistor Q1 flows through the base of the replica transistor Q11.

The current mirror circuit 62 is connected between the power supply node Nvdd and the replica transistor Q11 and the current mirror circuit 62. An input side of the current mirror circuit 62 is connected to a node between the load circuit 61 and the replica transistor Q11 via the transistor M16, and an output side is connected to the current mirror circuit 62.

The current mirror circuit 62 includes a transistor M13, a transistor M14, and a transistor M15. The transistor M13, the transistor M14, and the transistor M15 are connected in current mirror connection to each other. In a case where the replica transistor Q11 is an NPN type bipolar transistor and the transistors M13, M14, and M15 are P type field effect transistors, the transistor M13 has a source connected to the power supply node Nvdd, a drain connected to the base of the replica transistor Q11, and a gate connected to a gate of the transistor M14 and a gate of the transistor M15. The transistor M14 has a source connected to the power supply node Nvdd, and the gate and a drain connected to the gate of the transistor M13, the gate of the transistor M15, and the drain of the transistor M16. The transistor M15 has a source connected to the power supply node Nvdd, a drain connected to the current mirror circuit 63, and the gate connected to the gate of the transistor M13 and the gate of the transistor M14.

A size of the transistor M13, a size of the transistor M14, and a size of the transistor M15 are substantially equal. Accordingly, a mirror ratio is approximately 1.

Note that the transistor M16 has the gate connected to the drain of the transistor M11 and the source connected to the reference node Ng, and can function as an inverting amplifier.

A loop including the drain of the transistor M16 →the drain of the transistor M14→the gate of the transistor M14→the gate of the transistor M13→the drain of the transistor M13→the base of the replica transistor Q11→the collector of the replica transistor Q11→the gate of the transistor M16→the drain of the transistor M16 functions as a feedback loop. For example, a voltage corresponding to the current Ic from the load circuit 61 is applied to the gate of the transistor M16, and accordingly, a drain current flowing through the transistor M16 is copied from the drain of the transistor M14 to the drain of the transistor M13 at a mirror ratio of approximately 1. The copied current flows into the base of the replica transistor Q11, but since the load circuit 61 supplies the current Ic, a feedback is provided so that the drain current flowing through the transistor M16 becomes I_{B1}.

The current mirror circuit 62 receives the base current I_{B1} of the replica transistor Q11 on the input side, copies the current I_{B1} to the output side at a mirror ratio of approximately 1, and supplies the current I_{B1} from the output side to the current mirror circuit 63.

An input side of the current mirror circuit 63 is connected to the output side of the current mirror circuit 62, and an output side is connected to the resistance element R1 parallelly with respect to the node N1 and connected to the compensation circuit 7 parallelly with respect to the node N3. The node N3 is disposed between the current mirror circuit 5 and the compensation circuit 7.

The current mirror circuit 63 includes a transistor M17, a transistor M18, and a transistor M19. The transistor M17, the transistor M18, and the transistor M19 are connected in current mirror connection to each other. In a case where the transistors Q1 and Q2 are NPN type bipolar transistors and the transistors M17, M18, and M19 are N type field effect transistors, the transistor M17 has a source connected to the reference node Ng, and a gate and a drain connected to a gate of the transistor M18 and a gate of the transistor M19. The transistor M18 has a source connected to the reference node Ng, a drain connected to the node N1, and the gate connected to the gate of the transistor M17 and the gate of the transistor M18. The transistor M19 has a source connected to the reference node Ng, a drain connected to the node N3, and the gate connected to the gate of the transistor M17 and the gate of the transistor M18.

A size of the transistor M17, a size of the transistor M18, and a size of the transistor M19 are substantially equal to each other. Accordingly, a mirror ratio is approximately 1.

The current mirror circuit 63 receives the current I_{B1} on an input side, copies the current I_{B1} to an output side at a mirror ratio of approximately 1, and causes the current I_{B1} to flow on the output side. As a result, the current mirror circuit 63 extracts the base current I_{B1} from the node N1 and extracts the base current I_{B1} from the node N3.

The current mirror circuit 5 is connected between the transistor Q1, the transistor Q2, and the compensation circuit 7. In a case where the transistors Q1 and Q2 are NPN type bipolar transistors, an input side of the current mirror circuit 5 is connected to the node between the load circuit 4 and the transistor Q2 via the transistor M6, and an output side is connected to the compensation circuit 7.

As illustrated in FIG. 3, the current mirror circuit 5 includes a transistor M3, a transistor M4, and a transistor M5. The transistor M3, the transistor M4, and the transistor M5 are connected to each other in current mirror connection. In a case where the transistors Q1 and Q2 are NPN type bipolar transistors and the transistors M3, M4, and M5 are P type field effect transistors, the transistor M3 has a source connected to the power supply node Nvdd, a drain connected to the base of the transistor Q1 and the base of the transistor Q2, and a gate connected to a gate of the transistor M4 and a gate of the transistor M5. The transistor M4 has a source connected to the power supply node Nvdd, a drain connected to the compensation circuit 7, and the gate connected to the gate of the transistor M3 and the gate of the transistor M4. The transistor M5 has a source connected to the power supply node Nvdd, and the gate and a drain connected to the gate of the transistor M3, the gate of the transistor M4, and the drain of the transistor M6.

A size of the transistor M3, a size of the transistor M4, and a size of the transistor M5 are substantially equal. Accordingly, a mirror ratio is approximately 1.

Note that the transistor M6 has the gate connected to the drain of the transistor M2 and the source connected to the reference node Ng, and can function as an inverting amplifier.

A loop including the drain of the transistor M6→the drain of the transistor M5→the gate of the transistor M5→the gate of the transistor M3→the drain of the transistor M3→the base of the transistor Q2→the collector of the transistor Q2→the gate of the transistor M6→the drain of the transistor M6 functions as a feedback loop. For example, a voltage corresponding to the current Ic from the load circuit 4 is applied to the gate of the transistor M6, and accordingly, a drain current flowing through the transistor M6 is copied from the drain of the transistor M5 to the drain of the transistor M3 at a mirror ratio of approximately 1. The copied current flows into the base of the transistor Q1 and the base of the transistor Q2, but since the load circuit 4 supplies equivalent currents to the transistor Q1 and the transistor Q2, a feedback is provided so that the drain current flowing through the transistor M6 becomes I_{B1}+I_{B2}.

The current mirror circuit 5 receives a current I_{B1}+I_{B2} obtained by summing the base current I_{B} of the transistor Q1 and the base current I_{B} of the transistor Q2, on the input side (the drain of the transistor M5), copies the current I_{B1}+I_{B2} to the output side (the drain of the transistor M4) at a mirror ratio of approximately 1, and supplies the current I_{B1}+I_{B2} from the output side to the side of the compensation circuit 7.

The compensation circuit 7 illustrated in FIG. 2 is connected between the node N1, the node N2, and the node N3 and the reference node Ng.

As illustrated in FIG. 3, the compensation circuit 7 includes a current mirror circuit 73. An input side of the current mirror circuit 73 is connected to the output side of the current mirror circuit 5 via the node N3 and is connected to the current mirror circuit 63 parallelly with respect to the node N3, and an output side is connected to the resistance element R2 parallelly with respect to the node N2.

The current mirror circuit 73 includes a transistor M7 and a transistor M9. The transistor M7 and the transistor M9 are connected in current mirror connection to each other. In a case where the transistors Q1 and Q2 are NPN type bipolar transistors and the transistors M7, M8, and M9 are N type field effect transistors, the transistor M7 has a source connected to the reference node Ng, and a gate and a drain connected to a gate of the transistor M9 and the node N3. The transistor M9 has a source connected to the reference node Ng, a drain connected to the node N2, and the gate connected to the gate of the transistor M7.

A size of the transistor M7 is substantially equal to a size of the transistor M9. Accordingly, a mirror ratio is approximately 1.

As mentioned before, the current mirror circuit 63 extracts the base current I_{B1} from the node N1 and extracts the base current I_{B1} from the node N3. The current I_{B1}+I_{B2} flows into the node N3 from the current mirror circuit 5, but since the current mirror circuit 63 extracts the current I_{B1} from the node N3, the current I_{B2} is supplied to the current mirror circuit 73.

The current mirror circuit 73 receives the current I_{B2} on an input side, copies the current I_{B2} to an output side at a mirror ratio of approximately 1, and causes the current I_{B2} to flow on the output side. As a result, the current mirror circuit 73 extracts the base current I_{B2} from the node N2.

As described above, in the first embodiment, in the constant voltage generation circuit 1 of the semiconductor integrated circuit 100, the compensation circuit 6 generates the current I_{B1} corresponding to the base current of the transistor Q1 and extracts the current I_{B1} from the node N1. In addition, the current mirror circuit 5 supplies the total current I_{B1}+I_{B2} obtained by summing the currents received from the bases of the transistors Q1 and Q2 to the node N3, the compensation circuit 6 extracts the current I_{B1} from the node N3, and the remaining current I_{B2} is supplied to the compensation circuit 7. The compensation circuit 7 copies the received current I_{B2} to the output side at a mirror ratio of approximately 1, and extracts the base current I_{B2} from the node N2 on the output side. As a result, while suppressing an influence of the temperature dependence of the base currents of the transistors Q1 and Q2, the influence of the temperature dependence of the base-emitter voltages of the transistors Q1 and Q2 that can change with a negative increasing function with respect to the temperature can be substantially canceled by the temperature dependence of the voltage across the terminals of the resistance element R2 that can change with a positive increasing function with respect to temperature. As a result, the voltage between the collectors of the transistors Q1 and Q2 and the reference node Ng can be maintained substantially constant with respect to the fluctuation of the environmental temperature, and the constant voltage Vbgr output from the output node Nout can be maintained substantially constant.

In addition, in the first embodiment, in the constant voltage generation circuit 1 of the semiconductor integrated circuit 100, an operation in which the compensation circuit 6 extracts the current I_{B1} corresponding to the base current of Q1 and an operation in which the compensation circuit 7 extracts the current I_{B2} corresponding to the base current of the transistor Q2 are performed. As a result, while suppressing the influence of the difference between the base currents I_{B1} and I_{B2} according to the difference in the sizes of the transistors Q1 and Q2, the influence of the temperature dependence of the base-emitter voltages of the transistors Q1 and Q2 that can change with a negative increasing function with respect to the temperature can be substantially canceled by the temperature dependence of the voltage across the terminals of the resistance element R2 that can change with a positive increasing function with respect to temperature.

Note that, as a first modification of the first embodiment, in a constant voltage generation circuit 201 of a semiconductor integrated circuit 200, for example, it is possible to devise measures to stably equalize a collector current I_{C} of the transistor Q1 and a collector current I_{C} of the transistor Q2, in a case where the transistors Q1 and Q2 are NPN type bipolar transistors.

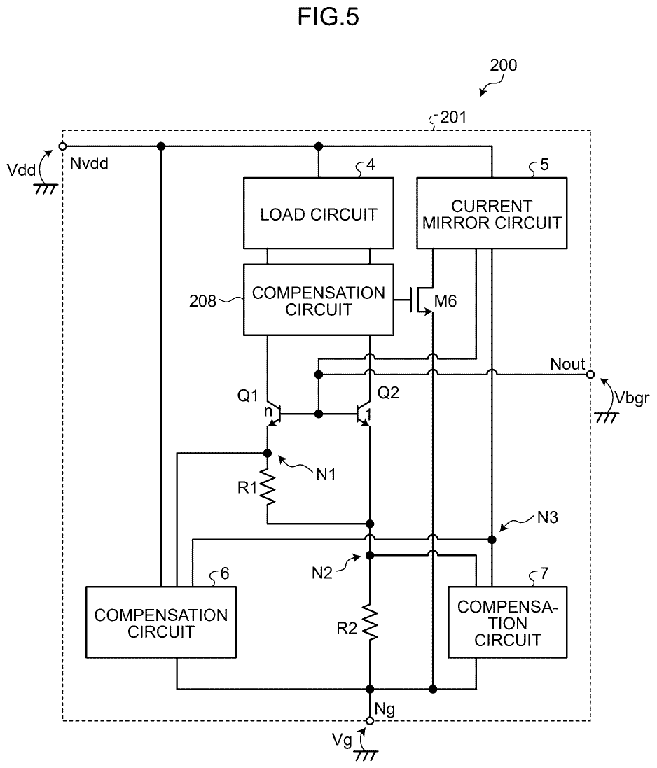

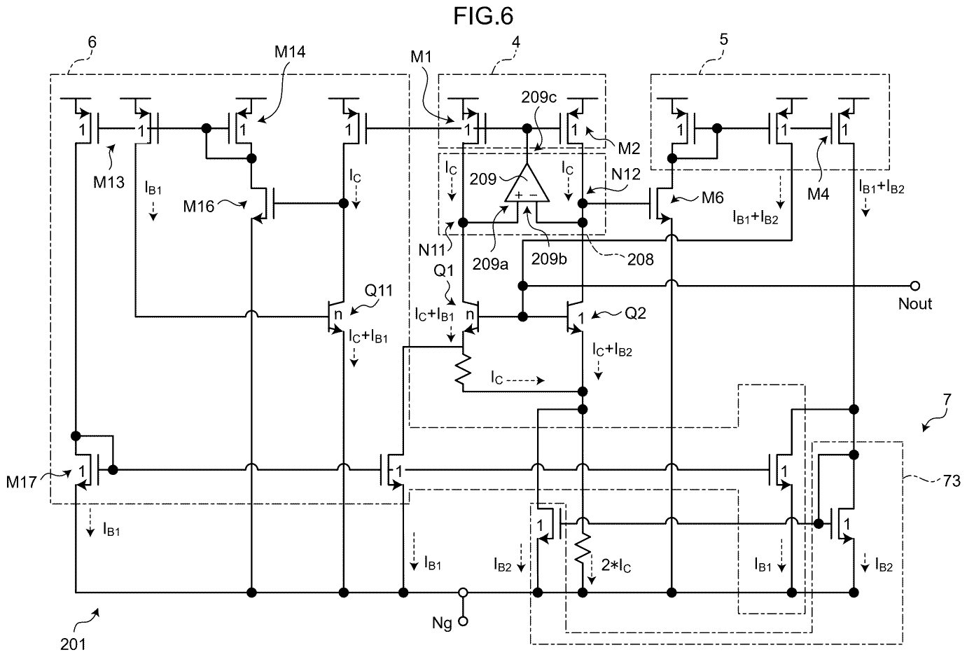

As illustrated in FIGS. 5 and 6, the constant voltage generation circuit 201 of the semiconductor integrated circuit 200 may further include a compensation circuit 208. FIG. 5 is a circuit diagram illustrating a schematic configuration of the constant voltage generation circuit 201 in the first modification of the embodiment. FIG. 6 is a circuit diagram illustrating a detailed configuration of the constant voltage generation circuit 201 in the first modification of the embodiment.

The compensation circuit 208 illustrated in FIG. 5 is connected between the load circuit 4, the transistors Q1 and Q2, and the transistor M6. The compensation circuit 208 receives a voltage on a side of the transistor Q1 and a voltage on a side of the transistor Q2 from the load circuit 4, and supplies a control signal corresponding to a difference between a current on a side of the transistor Q1 and a current on a side of the transistor Q2 to the load circuit 4.

As illustrated in FIG. 6, the compensation circuit 208 includes a differential amplifier 209. The differential amplifier 209 has a non-inverting input terminal 209a connected to a node N11, an inverting input terminal 209b connected to a node N12, and an output terminal 209c connected to the gates of the transistors M1 and M2. The node N11 is connected between the load circuit 4 and the transistor Q1. The node N12 is connected between the load circuit 4 and the transistor Q2.

In a case where the transistors M1 and M2 are P type field effect transistors and the transistors Q1 and Q2 are NPN type bipolar transistors, the node N11 is connected between the drain of the transistor M1 and the collector of the transistor Q1. The node N12 is connected between the drain of the transistor M2 and the collector of the transistor Q2. The transistors M1 and M2 can also be regarded to be connected in current mirror connection via the differential amplifier 209.

The differential amplifier 209 receives a voltage of the node N11 by the non-inverting input terminal 209a and receives a voltage of the node N12 by the inverting input terminal 209b. The differential amplifier 209 outputs a voltage corresponding to a difference between the voltage of the node N11 and the voltage of the node N12 from the output terminal 209c. The differential amplifier 209 may supply the voltage corresponding to the difference between the voltage of the node N11 and the voltage of the node N12 to the load circuit 4 as a control signal.

As a result, the compensation circuit 208 can adjust the load circuit 4 so that the current on the side of the transistor Q1 and the current on the side of the transistor Q2 become equivalent. According to the adjustment result, the compensation circuit 208 supplies the current on the side of the transistor Q1 to the transistor Q1 and supplies the current on the side of the transistor Q2 to the transistor Q2.

Note that the loop including the drain of the transistor M6→the drain of the transistor M5→the gate of the transistor M5→the gate of the transistor M3→the drain of the transistor M3→the base of the transistor Q2 →the collector of the transistor Q2→the gate of the transistor M6→the drain of the transistor M6 functions as a feedback loop. For example, a voltage corresponding to the current Ic from the load circuit 4 is applied to the gate of the transistor M6, and accordingly, a drain current flowing through the transistor M6 is copied from the drain of the transistor M5 to the drain of the transistor M3 at a mirror ratio of approximately 1. The copied current flows into the base of the transistor Q1 and the base of the transistor Q2, but since the load circuit 4 supplies the current Ic to each of the transistor Q1 and the transistor Q2, a feedback is provided so that the drain current flowing through the transistor M6 becomes I_{B1}+I_{B2}. This point is similar to the first embodiment.

In this way, the compensation circuit 208 can perform compensation such that the load circuit 4 stably supplies the equivalent currents to the transistor Q1 and the transistor Q2. As a result, the collector current I_{C} of the transistor Q1 and the collector current I_{C} of the transistor Q2 can be stably equalized.

Alternatively, as a second modification of the first embodiment, in a constant voltage generation circuit 301 of a semiconductor integrated circuit 300, for example, it is possible to devise measures to suppress an influence of a difference between the collector current I_{C} of the transistor Q1 and the collector current I_{C} of the transistor Q2, in a case where the transistors Q1 and Q2 are NPN type bipolar transistors.

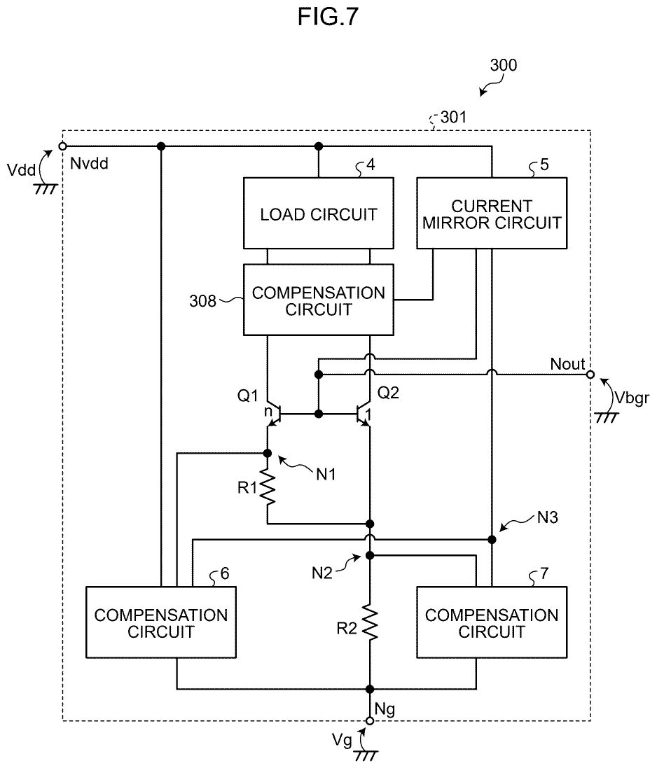

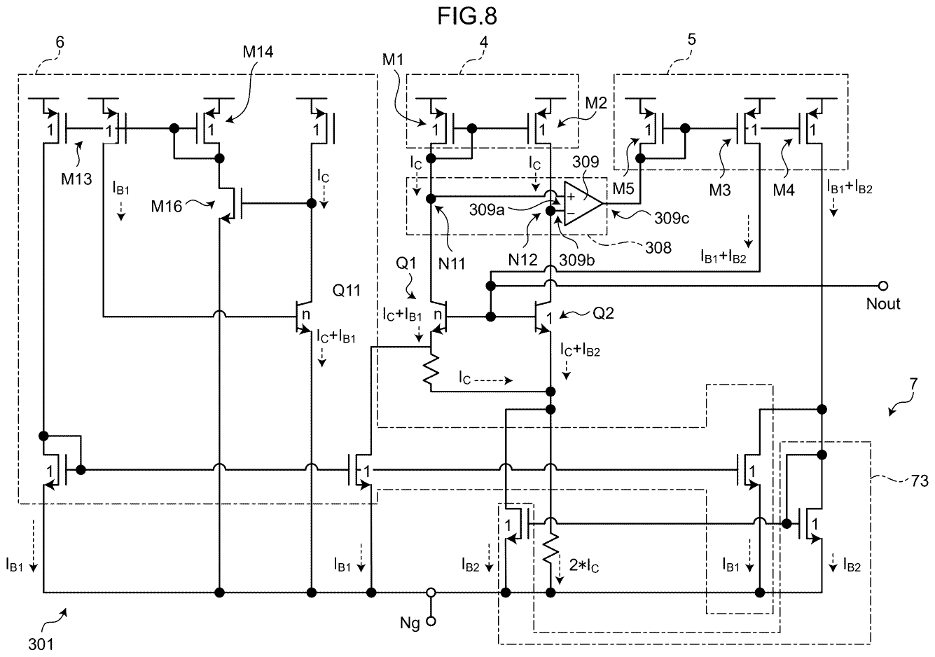

As illustrated in FIGS. 7 and 8, the constant voltage generation circuit 301 of the semiconductor integrated circuit 300 may further include a compensation circuit 308. FIG. 7 is a circuit diagram illustrating a schematic configuration of the constant voltage generation circuit 301 in the second modification of the embodiment. FIG. 8 is a circuit diagram illustrating a detailed configuration of the constant voltage generation circuit 301 in the second modification of the embodiment.

The compensation circuit 308 illustrated in FIG. 7 is connected between the load circuit 4 and the current mirror circuit 5 and the transistors Q1 and Q2. The compensation circuit 308 receives a voltage on a side of the transistor Q1 and a voltage on a side of the transistor Q2 from the load circuit 4, and supplies a control signal corresponding to a difference between a current on a side of the transistor Q1 and a current on a side of the transistor Q2 to the current mirror circuit 5.

As illustrated in FIG. 8, the compensation circuit 308 includes a differential amplifier 309. The differential amplifier 309 has a non-inverting input terminal 309a connected to the node N11, an inverting input terminal 309b connected to the node N12, and an output terminal 309c connected to the drain of the transistor M5. The node N11 is connected between the load circuit 4 and the transistor Q1. The node N12 is connected between the load circuit 4 and the transistor Q2.

In a case where the transistors M1 and M2 are P type field effect transistors and the transistors Q1 and Q2 are NPN type bipolar transistors, the node N11 is connected between the drain of the transistor M1 and the collector of the transistor Q1. The node N12 is connected between the drain of the transistor M2 and the collector of the transistor Q2.

The differential amplifier 309 receives the voltage of the node N11 by the non-inverting input terminal 309a and receives the voltage of the node N12 by the inverting input terminal 309b. The differential amplifier 309 outputs a voltage corresponding to a difference between the voltage of the node N11 and the voltage of the node N12 from the output terminal 309c. The differential amplifier 309 may supply the voltage corresponding to the difference between the voltage of the node N11 and the voltage of the node N12 to the current mirror circuit 5 as a control signal.

As a result, the current mirror circuit 5 copies a correction current corresponding to the difference between the collector current on the side of the transistor Q1 and the collector current on the side of the transistor Q2 to the input side and the output side at a mirror ratio of approximately 1, supplies the correction current from the input side to the transistors Q1 and Q2, and supplies the correction current from the output side to the compensation circuit 6.

Note that a loop including the output node 309c of the differential amplifier 309→the drain of the transistor M5→the gate of the transistor M5→the gate of the transistor M3→the drain of the transistor M3→the base of the transistor Q2→the collector of the transistor Q2→the input node 309b of the differential amplifier 309 →the output node 309c of the differential amplifier 309 functions as a feedback loop. For example, a voltage corresponding to the current Ic from the load circuit 4 is applied to the input node 309b of the differential amplifier 309, and accordingly, the current flowing through the output node 309c of the differential amplifier 309 is copied from the drain of the transistor M5 to the drain of the transistor M3 at a mirror ratio of approximately 1. The copied current flows into the base of the transistor Q1 and the base of the transistor Q2, but since the load circuit 4 supplies the current Ic to each of the transistor Q1 and the transistor Q2, a feedback is provided so that the drain current flowing through the transistor M6 becomes I_{B1}+I_{B2}. This point is similar to the first embodiment.

In this way, in the compensation circuit 308, the current mirror circuit 5 causes the correction current corresponding to the difference between the collector current on the side of the transistor Q1 and the collector current on the side of the transistor Q2 to flow to the input side and the output side of the current mirror circuit 5. As a result, the currents I_{B1}+I_{B2} flowing on the input side and the output side of the current mirror circuit 5 may be corrected, and it is possible to suppress the influence of the difference between the collector current I_{C} of the transistor Q1 and the collector current I_{C} of the transistor Q2.

### Second Embodiment

Next, a semiconductor integrated circuit according to a second embodiment will be described. Hereinafter, portions different from those of the first embodiment will be mainly described.

In the first embodiment, the configuration in which the current I_{B1} is generated and the current I_{B1} is subtracted from the current I_{B1}+I_{B2} to obtain the current I_{B2} is exemplified, but in the second embodiment, a configuration in which a current I_{B2} is generated and a current I_{B2} is subtracted from a current I_{B1}+I_{B2} to obtain the current I_{B1} is exemplified.

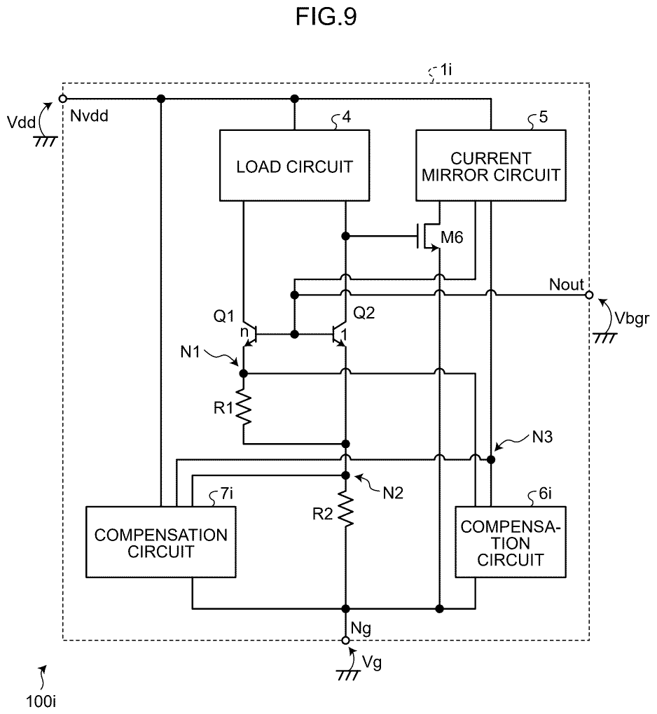

The semiconductor integrated circuit 100i can be configured as illustrated in FIG. 9. FIG. 9 is a circuit diagram illustrating a schematic configuration of a semiconductor integrated circuit 100i.

The semiconductor integrated circuit 100i includes a compensation circuit 6i and a compensation circuit 7i instead of the compensation circuit 6 and the compensation circuit 7 (see FIG. 2).

The compensation circuit 7i is connected between a power supply node Nvdd, a node N2, a node N3, and a reference node Ng. The compensation circuit 7i generates a current I_{B2} corresponding to a base current I_{B2} of a transistor Q2, and extracts a current I_{B2} from the nodes N2 and N3.

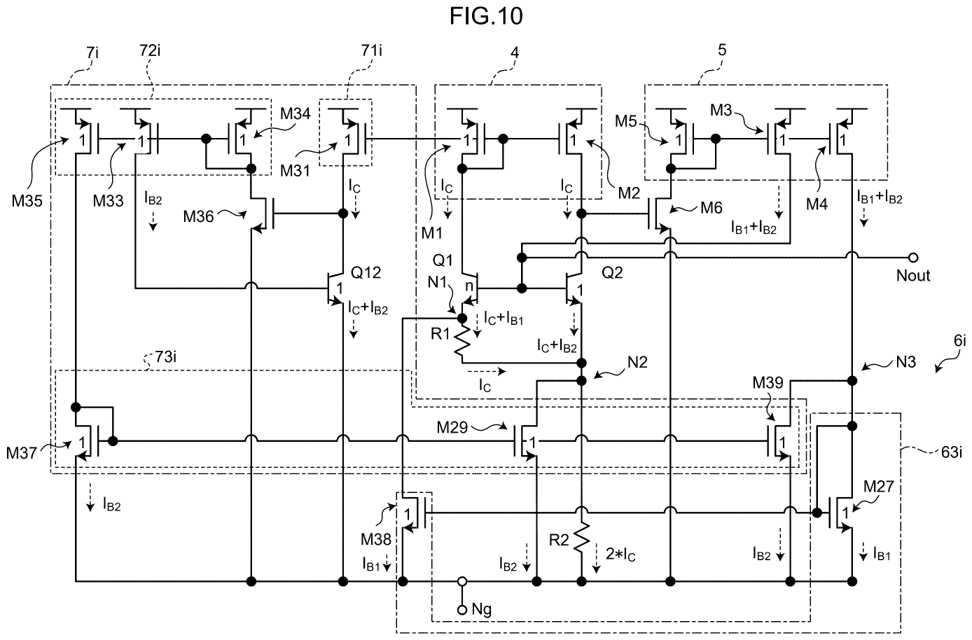

As illustrated in FIG. 10, the compensation circuit 7i includes a load circuit 71i, a replica transistor Q12, a current mirror circuit 72i, and a current mirror circuit 73i. FIG. 10 is a circuit diagram illustrating a detailed configuration of a constant voltage generation circuit 1i according to the second embodiment.

The load circuit 71i is connected between the power supply node Nvdd and the replica transistor Q12. In a case where the replica transistor Q12 is an NPN type bipolar transistor, the load circuit 71i is connected between the power supply node Nvdd and a collector of the replica transistor Q12.

The load circuit 71i includes a transistor M31. The transistor M31 is connected between the power supply node Nvdd and the replica transistor Q12. In a case where the replica transistor Q12 is an NPN type bipolar transistor, the transistor M31 is connected between the power supply node Nvdd and the collector of the replica transistor Q12.

The replica transistor Q12 is connected between the load circuit 71i, the current mirror circuit 72i, and the reference node Ng. The replica transistor Q12 may be an NPN type bipolar transistor. The replica transistor Q12 has the collector connected to the load circuit 71i, an emitter connected to the reference node Ng, and a base connected to the current mirror circuit 72i.

The replica transistor Q12 is provided as a replica of the transistor Q2. A size of the replica transistor Q12 is substantially equal to the size of the transistor Q2. As a result, a current I_{B2} corresponding to the base current I_{B2} of the transistor Q2 flows through the base of the replica transistor Q12.

The current mirror circuit 72i is connected between the power supply node Nvdd and the replica transistor Q12 and the current mirror circuit 73i. An input side of the current mirror circuit 72i is connected to the base of the replica transistor Q12 and an output side is connected to the current mirror circuit 73i.

The current mirror circuit 72i includes a transistor M33, a transistor M34, and a transistor M35. The transistor M33, the transistor M34, and the transistor M35 are connected in current mirror connection to each other. In a case where the replica transistor Q12 is an NPN type bipolar transistor and the transistors M33, M34, and M35 are P type field effect transistors, the transistor M33 has a source connected to the power supply node Nvdd, a drain connected to the base of the replica transistor Q12, and a gate connected to a gate of the transistor M34 and a gate of the transistor M35. The transistor M34 has a source connected to the power supply node Nvdd, and the gate and a drain connected to the gate of the transistor M33, the gate of the transistor M35, and the drain of the transistor M36. The transistor M35 has a source connected to the power supply node Nvdd, a drain connected to the current mirror circuit 73i, and the gate connected to the gate of the transistor M33 and the gate of the transistor M34.

A size of the transistor M33, a size of the transistor M34, and a size of the transistor M35 are substantially equal. Accordingly, a mirror ratio is approximately 1.

Note that the transistor M36 has the gate connected to the drain of the transistor M31 and the source connected to the reference node Ng, and can function as an inverting amplifier.

A loop including the drain of the transistor M36 →the drain of the transistor M34→the gate of the transistor M34→the gate of the transistor M33→the drain of the transistor M33→the base of the replica transistor Q12→the collector of the replica transistor Q12→the gate of the transistor M36→the drain of the transistor M36 functions as a feedback loop. For example, a voltage corresponding to the current Ic from the load circuit 71i is applied to the gate of the transistor M36, and accordingly, a drain current flowing through the transistor M36 is copied from the drain of the transistor M34 to the drain of the transistor M33 at a mirror ratio of approximately 1. The copied current flows into the base of the replica transistor Q12, but since the load circuit 71i supplies the current Ic, a feedback is provided so that the drain current flowing through the transistor M36 becomes I_{B2}.

The current mirror circuit 72i receives the base current I_{B2} of the replica transistor Q12 on the input side (the drain of the transistor M 34), copies the current I_{B2} to the output side (the drain of the transistor M 35) at a mirror ratio of approximately 1, and supplies the current I_{B2} from the output side to the current mirror circuit 73i.

An input side of the current mirror circuit 73i is connected to the output side of the current mirror circuit 72i, and an output side is connected to the resistance element R2 parallelly with respect to the node N2 and connected to the compensation circuit 6i parallelly with respect to the node N3. The node N3 is disposed between the current mirror circuit 5 and the compensation circuit 6i.

The current mirror circuit 73i includes a transistor M37, a transistor M29, and a transistor M39. The transistor M37, the transistor M29, and the transistor M39 are connected in current mirror connection to each other. In a case where the transistors M37, M29, and M39 are N type field effect transistors, the transistor M37 has a source connected to the reference node Ng, and a gate and a drain connected to a gate of the transistor M38 and a gate of the transistor M39. The transistor M29 has a source connected to the reference node Ng, a drain connected to the node N2, and the gate connected to the gate of the transistor M37 and the gate of the transistor M29. The transistor M39 has a source connected to the reference node Ng, a drain connected to the node N3, and the gate connected to the gate of the transistor M37 and the gate of the transistor M29.

A size of the transistor M37, a size of the transistor M29, and a size of the transistor M39 are substantially equal to each other. Accordingly, a mirror ratio is approximately 1.

The current mirror circuit 73i receives the current I_{B2} on an input side, copies the current I_{B2} to an output side at a mirror ratio of approximately 1, and causes the current I_{B2} to flow on the output side. As a result, the current mirror circuit 73i extracts the base current I_{B2} from the node N2 and extracts the base current I_{B2} from the node N3.

The current mirror circuit 5 is connected between the transistor Q1, the transistor Q2, and the compensation circuit 6i. In a case where the transistors Q1 and Q2 are NPN type bipolar transistors, an input side of the current mirror circuit 5 is connected to the node between the load circuit 4 and the transistor Q2 via the transistor M6, and an output side is connected to the compensation circuit 6i.

As illustrated in FIG. 10, the current mirror circuit 5 includes a transistor M3, a transistor M4, and a transistor M5. The transistor M3, the transistor M4, and the transistor M5 are connected to each other in current mirror connection. In a case where the transistors Q1 and Q2 are NPN type bipolar transistors and the transistors M3, M4, and M5 are P type field effect transistors, the transistor M3 has a source connected to the power supply node Nvdd, a drain connected to the base of the transistor Q1 and the base of the transistor Q2, and a gate connected to a gate of the transistor M4 and a gate of the transistor M5. The transistor M4 has a source connected to the power supply node Nvdd, a drain connected to the compensation circuit 6i, and the gate connected to the gate of the transistor M3 and the gate of the transistor M4. The transistor M5 has a source connected to the power supply node Nvdd, and the gate and a drain connected to the gate of the transistor M3, the gate of the transistor M4, and the drain of the transistor M6.

A size of the transistor M3, a size of the transistor M4, and a size of the transistor M5 are substantially equal. Accordingly, a mirror ratio is approximately 1.

Note that the transistor M6 has the gate connected to the drain of the transistor M2 and the source connected to the reference node Ng, and can function as an inverting amplifier.

A loop including the drain of the transistor M6→the drain of the transistor M5→the gate of the transistor M5→the gate of the transistor M3→the drain of the transistor M3→the base of the transistor Q2→the collector of the transistor Q2→the gate of the transistor M6→the drain of the transistor M6 functions as a feedback loop. For example, a voltage corresponding to the current Ic from the load circuit 4 is applied to the gate of the transistor M6, and accordingly, a drain current flowing through the transistor M6 is copied from the drain of the transistor M5 to the drain of the transistor M3 at a mirror ratio of approximately 1. The copied current flows into the base of the transistor Q1 and the base of the transistor Q2, but since the load circuit 4 supplies equivalent currents to the transistor Q1 and the transistor Q2, a feedback is provided so that the drain current flowing through the transistor M6 becomes I_{B1}+I_{B2}.

The current mirror circuit 5 receives a current I_{B1}+I_{B2} obtained by summing the base current I_{B1} of the transistor Q1 and the base current I_{B2} of the transistor Q2, on the input side, copies the current I_{B1}+I_{B2} to the output side at a mirror ratio of approximately 1, and supplies the current I_{B1}+I_{B2} from the output side to the side of the compensation circuit 6i.

The compensation circuit 6i illustrated in FIG. 9 is connected between the nodes N1 and N3 and the reference node Ng.

As illustrated in FIG. 10, the compensation circuit 6i includes a current mirror circuit 63i. An input side of the current mirror circuit 63i is connected to the output side of the current mirror circuit 5 via the node N3 and is connected to the current mirror circuit 73i parallelly with respect to the node N3, and an output side is connected to the resistance element R1 parallelly with respect to the node N1.

The current mirror circuit 63i includes a transistor M27 and a transistor M38. The transistor M27 and the transistor M38 are connected in current mirror connection to each other. In a case where the transistors Q1 and Q2 are NPN type bipolar transistors and the transistors M27 and M38 are N type field effect transistors, the transistor M27 has a source connected to the reference node Ng, and a gate and a drain connected to a gate of the transistor M38 and the node N3. The transistor M38 has a source connected to the reference node Ng, a drain connected to the node N1, and the gate connected to the gate of the transistor M27.

A size of the transistor M27 is substantially equal to a size of the transistor M38. Accordingly, a mirror ratio is approximately 1.

As mentioned before, the current mirror circuit 73i extracts the base current I_{B2} from the node N2 and extracts the base current I_{B2} from the node N3. The current I_{B1}+I_{B2} flows into the node N3 from the current mirror circuit 5, but since the current mirror circuit 73i extracts the current I_{B2} from the node N3, the current I_{B1} is supplied to the current mirror circuit 63i.

The current mirror circuit 63i receives the current I_{B1} on an input side, copies the current I_{B1} to an output side at a mirror ratio of approximately 1, and causes the current I_{B1} to flow on the output side. As a result, the current mirror circuit 63i extracts the base current I_{B1} from the node N1.

As described above, in the second embodiment, in the constant voltage generation circuit 1i of the semiconductor integrated circuit 100i, the compensation circuit 7i generates the current I_{B2} corresponding to the base current of the transistor Q2 and extracts the current I_{B2} from the node N2. In addition, the current mirror circuit 5 supplies the total current I_{B1}+I_{B2} obtained by summing the currents received from the bases of the transistors Q1 and Q2 to the node N3, and supplies the summed current I_{B1}+I_{B2} to the node N3, the compensation circuit 7i extracts the current I_{B2} from the node N3, and the remaining current I_{B1} is supplied to the compensation circuit 6i. The compensation circuit 6i copies the received current I_{B1} to the output side at a mirror ratio of approximately 1, and extracts the base current I_{B1} from the node N1 on the output side. As a result, while suppressing an influence of the temperature dependence of the base currents of the transistors Q1 and Q2, the influence of the temperature dependence of the base-emitter voltages of the transistors Q1 and Q2 that can change with a negative increasing function with respect to the temperature can be reduced by the temperature dependence of the voltage across the terminals of the resistance element R2 that can change with a positive increasing function with respect to temperature. As a result, the voltage between the collectors of the transistors Q1 and Q2 and the reference node Ng can be maintained substantially constant with respect to the fluctuation of the environmental temperature, and the constant voltage Vbgr output from the output node Nout can be maintained substantially constant.

In addition, in the second embodiment, in the constant voltage generation circuit 1i of the semiconductor integrated circuit 100i, an operation in which the compensation circuit 6i extracts the current I_{B1} corresponding to the base current of Q1 and an operation in which the compensation circuit 7i extracts the current I_{B2} corresponding to the base current of the transistor Q2 are performed. As a result, while suppressing the influence of the difference between the base currents I_{B1} and I_{B2} according to the difference in the sizes of the transistors Q1 and Q2, it is possible to reduce the influence of the temperature dependence of the base-emitter voltages of the transistors Q1 and Q2, which can change with a negative increasing function with respect to the temperature, by the temperature dependence of the voltage between both ends of the resistance element R2, which can change with a positive increasing function with respect to the temperature.

Note that, as a first modification of the second embodiment, in a constant voltage generation circuit 201i of a semiconductor integrated circuit 200i, for example, it is possible to devise measures to stably equalize a collector current I_{C} of the transistor Q1 and a collector current I_{C} of the transistor Q2, in a case where the transistors Q1 and Q2 are NPN type bipolar transistors.

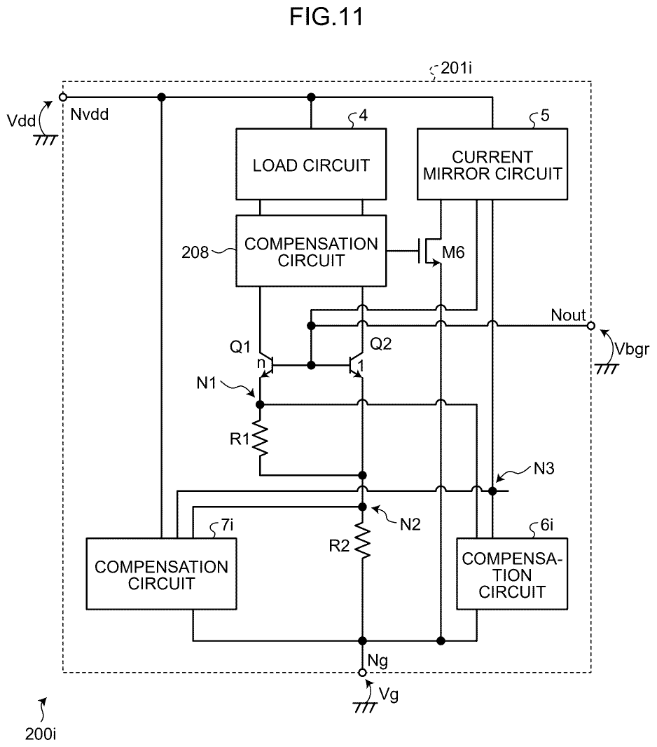

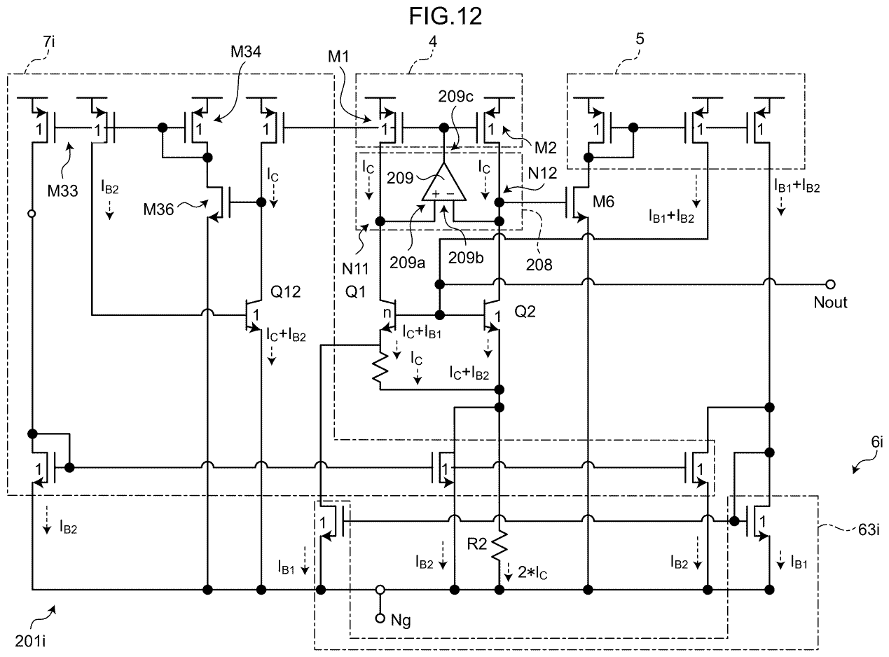

As illustrated in FIGS. 11 and 12, the constant voltage generation circuit 201i of the semiconductor integrated circuit 200i may further include a compensation circuit 208. FIG. 11 is a circuit diagram illustrating a detailed configuration of the constant voltage generation circuit 201i in the first modification of the second embodiment. FIG. 12 is a circuit diagram illustrating a detailed configuration of the constant voltage generation circuit 201i in the first modification of the second embodiment.

The compensation circuit 208 illustrated in FIG. 11 is connected between the load circuit 4, the transistors Q1 and Q2, and the transistor M6. The compensation circuit 208 receives a voltage on a side of the transistor Q1 and a voltage on a side of the transistor Q2 from the load circuit 4, and supplies a control signal corresponding to a difference between a current on a side of the transistor Q1 and a current on a side of the transistor Q2 to the load circuit 4.

As illustrated in FIG. 12, the compensation circuit 208 includes a differential amplifier 209. The differential amplifier 209 has a non-inverting input terminal 209a connected to a node N11, an inverting input terminal 209b connected to a node N12, and an output terminal 209c connected to the gates of the transistors M1 and M2. The node N11 is connected between the load circuit 4 and the transistor Q1. The node N12 is connected between the load circuit 4 and the transistor Q2.

In a case where the transistors M1 and M2 are P type field effect transistors and the transistors Q1 and Q2 are NPN type bipolar transistors, the node N11 is connected between the drain of the transistor M1 and the collector of the transistor Q1. The node N12 is connected between the drain of the transistor M2 and the collector of the transistor Q2. The transistors M1 and M2 can also be regarded to be connected in current mirror connection via the differential amplifier 209.

The differential amplifier 209 receives a voltage of the node N11 by the non-inverting input terminal 209a and receives a voltage of the node N12 by the inverting input terminal 209b. The differential amplifier 209 outputs a voltage corresponding to a difference between the voltage of the node N11 and the voltage of the node N12 from the output terminal 209c. The differential amplifier 209 may supply the voltage corresponding to the difference between the voltage of the node N11 and the voltage of the node N12 to the load circuit 4 as a control signal.

As a result, the compensation circuit 208 can adjust the load circuit 4 so that the current on the side of the transistor Q1 and the current on the side of the transistor Q2 become equivalent. According to the adjustment result, the compensation circuit 208 supplies the current on the side of the transistor Q1 to the transistor Q1 and supplies the current on the side of the transistor Q2 to the transistor Q2.

Note that a loop including the drain of the transistor M36→the drain of the transistor M34→the gate of the transistor M34→the gate of the transistor M33→the drain of the transistor M33→the base of the replica transistor Q11→the collector of the replica transistor Q11→the gate of the transistor M36→the drain of the transistor M36 functions as a feedback loop. For example, a voltage corresponding to the current Ic from the load circuit 61 is applied to the gate of the transistor M36, and accordingly, a drain current flowing through the transistor M36 is copied from the drain of the transistor M34 to the drain of the transistor M33 at a mirror ratio of approximately 1. The copied current flows into the base of the replica transistor Q11, but since the load circuit 61 supplies the current Ic, a feedback is provided so that the drain current flowing through the transistor M36 becomes I_{B2}. This point is similar to the second embodiment.

In addition, the loop including the drain of the transistor M6→the drain of the transistor M5→the gate of the transistor M5→the gate of the transistor M3→the drain of the transistor M3→the base of the transistor Q2 →the collector of the transistor Q2→the gate of the transistor M6→the drain of the transistor M6 functions as a feedback loop. For example, a voltage corresponding to the current Ic from the load circuit 4 is applied to the gate of the transistor M6, and accordingly, a drain current flowing through the transistor M6 is copied from the drain of the transistor M5 to the drain of the transistor M3 at a mirror ratio of approximately 1. The copied current flows into the base of the transistor Q1 and the base of the transistor Q2, but since the load circuit 4 supplies equivalent currents to the transistor Q1 and the transistor Q2, a feedback is provided so that the drain current flowing through the transistor M6 becomes I_{B1}+I_{B2}. This point is similar to the second embodiment.

In this way, the compensation circuit 208 can perform compensation such that the load circuit 4 stably supplies the equivalent currents to the transistor Q1 and the transistor Q2. As a result, the collector current I_{C} of the transistor Q1 and the collector current I_{C} of the transistor Q2 can be stably equalized.

Alternatively, as a second modification of the second embodiment, in a constant voltage generation circuit 301i of a semiconductor integrated circuit 300i, for example, it is possible to devise measures to suppress an influence of a difference between the collector current I_{C} of the transistor Q1 and the collector current I_{C} of the transistor Q2, in a case where the transistors Q1 and Q2 are NPN type bipolar transistors.

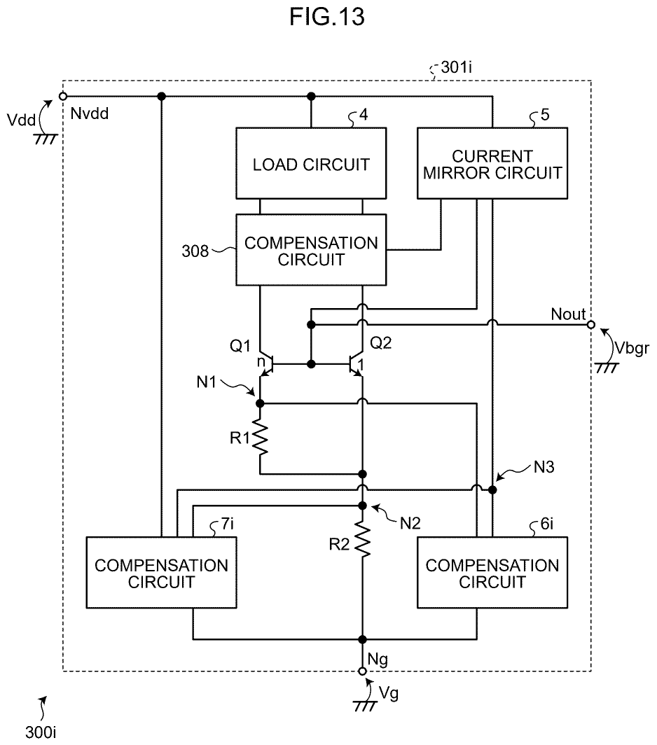

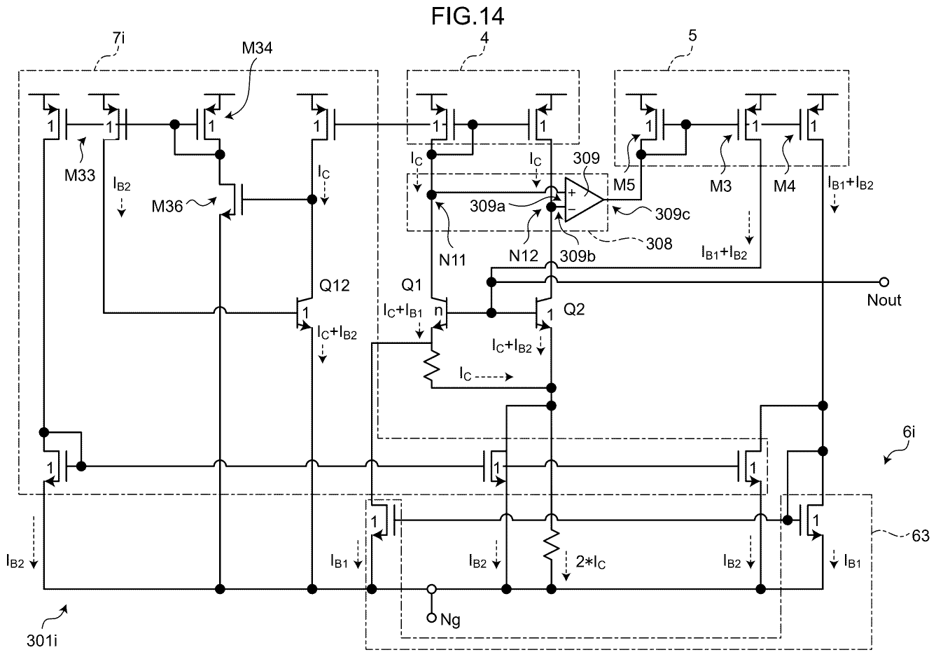

As illustrated in FIGS. 13 and 14, the constant voltage generation circuit 301i of the semiconductor integrated circuit 300i may further include a compensation circuit 308. FIG. 13 is a circuit diagram illustrating a detailed configuration of the constant voltage generation circuit 301i in the second modification of the second embodiment. FIG. 14 is a circuit diagram illustrating a detailed configuration of the constant voltage generation circuit 301i in the second modification of the second embodiment.

The compensation circuit 308 illustrated in FIG. 13 is connected between the load circuit 4 and the current mirror circuit 5 and the transistors Q1 and Q2. The compensation circuit 308 receives a voltage on a side of the transistor Q1 and a voltage on a side of the transistor Q2 from the load circuit 4, and supplies a control signal corresponding to a difference between a current on a side of the transistor Q1 and a current on a side of the transistor Q2 to the current mirror circuit 5.

As illustrated in FIG. 14, the compensation circuit 308 includes a differential amplifier 309. The differential amplifier 309 has a non-inverting input terminal 309a connected to the node N11, an inverting input terminal 309b connected to the node N12, and an output terminal 309c connected to the drain of the transistor M5. The node N11 is connected between the load circuit 4 and the transistor Q1. The node N12 is connected between the load circuit 4 and the transistor Q2.

In a case where the transistors M1 and M2 are P type field effect transistors and the transistors Q1 and Q2 are NPN type bipolar transistors, the node N11 is connected between the drain of the transistor M1 and the collector of the transistor Q1. The node N12 is connected between the drain of the transistor M2 and the collector of the transistor Q2.

The differential amplifier 309 receives the voltage of the node N11 by the non-inverting input terminal 309a and receives the voltage of the node N12 by the inverting input terminal 309b. The differential amplifier 309 outputs a voltage corresponding to a difference between the voltage of the node N11 and the voltage of the node N12 from the output terminal 309c. The differential amplifier 309 may supply the voltage corresponding to the difference between the voltage of the node N11 and the voltage of the node N12 to the current mirror circuit 5 as a control signal.

As a result, the current mirror circuit 5 copies a correction current corresponding to the difference between the collector current on the side of the transistor Q1 and the collector current on the side of the transistor Q2 to the input side and the output side at a mirror ratio of approximately 1, supplies the correction current from the input side to the transistors Q1 and Q2, and supplies the correction current from the output side to the compensation circuit 6.

Note that a loop including the drain of the transistor M36→the drain of the transistor M34→the gate of the transistor M34→the gate of the transistor M33→the drain of the transistor M33→the base of the replica transistor Q11→the collector of the replica transistor Q11→the gate of the transistor M36→the drain of the transistor M36 functions as a feedback loop. For example, a voltage corresponding to the current Ic from the load circuit 61 is applied to the gate of the transistor M36, and accordingly, a drain current flowing through the transistor M36 is copied from the drain of the transistor M34 to the drain of the transistor M33 at a mirror ratio of approximately 1. The copied current flows into the base of the replica transistor Q11, but since the load circuit 61 supplies the current Ic, a feedback is provided so that the drain current flowing through the transistor M36 becomes I_{B2}. This point is similar to the second embodiment.

In addition, the loop including the output node 309c of the differential amplifier 309→the drain of the transistor M5→the gate of the transistor M5→the gate of the transistor M3→the drain of the transistor M3→the base of the transistor Q2→the collector of the transistor Q2→the input node 309b of the differential amplifier 309 →the output node 309c of the differential amplifier 309 functions as a feedback loop. For example, a voltage corresponding to the current Ic from the load circuit 4 is applied to the input node 309b of the differential amplifier 309, and accordingly, the current flowing through the output node 309c of the differential amplifier 309 is copied from the drain of the transistor M5 to the drain of the transistor M3 at a mirror ratio of approximately 1. The copied current flows into the base of the transistor Q1 and the base of the transistor Q2, but since the load circuit 4 supplies equivalent currents to the transistor Q1 and the transistor Q2, a feedback is provided so that the current flowing through the output node 309c of the differential amplifier 309 becomes I_{B1}+I_{B2}. This point is similar to the second embodiment.

In this way, in the compensation circuit 308, the current mirror circuit 5 causes the correction current corresponding to the difference between the collector current on the side of the transistor Q1 and the collector current on the side of the transistor Q2 to flow to the input side and the output side of the current mirror circuit 5. As a result, the currents I_{B1}+I_{B2} flowing on the input side and the output side of the current mirror circuit 5 may be corrected, and it is possible to suppress the influence of the difference between the collector current I_{C} of the transistor Q1 and the collector current I_{C} of the transistor Q2.

### Third Embodiment

Next, a semiconductor integrated circuit according to a third embodiment will be described. Hereinafter, portions different from those of the first embodiment and the second embodiment will be mainly described.

In the first embodiment, the configuration in which the current I_{B1} is generated and the current I_{B1} is subtracted from the current I_{B1}+I_{B2} to obtain the current I_{B2} is exemplified, and in the second embodiment, a configuration in which the current I_{B2} is generated and the current I_{B2} is subtracted from the current I_{B1}+I_{B2} to obtain the current I_{B1} is exemplified, but in the third embodiment, a configuration in which currents I_{B1} and I_{B2} are respectively generated is exemplified.

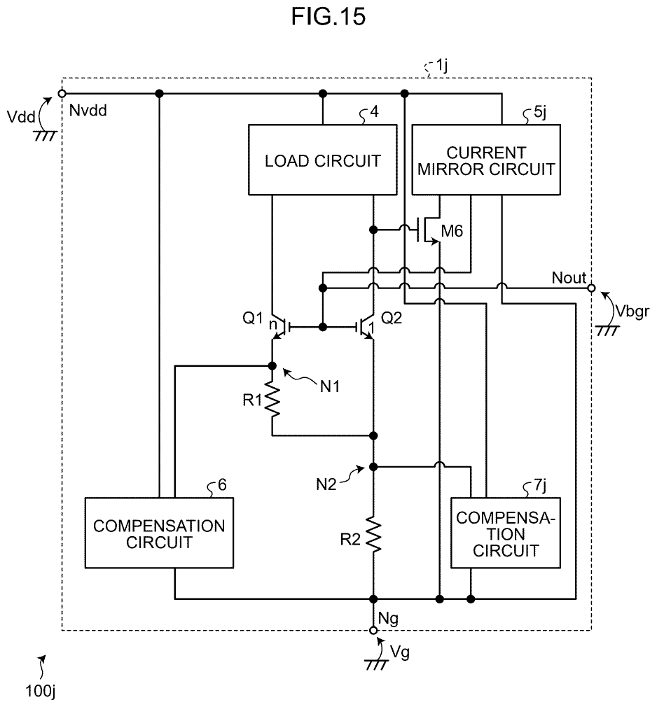

The semiconductor integrated circuit 100j can be configured as illustrated in FIG. 15. FIG. 15 is a circuit diagram illustrating a schematic configuration of a semiconductor integrated circuit 100j.

The semiconductor integrated circuit 100j includes a current mirror circuit 5j and a compensation circuit 7j instead of the current mirror circuit 5 and the compensation circuit 7 (see FIG. 2).

The current mirror circuit 5j is connected between a transistor Q1, a transistor Q2, and a reference node Ng. In a case where the transistors Q1 and Q2 are NPN type bipolar transistors, an input side of the current mirror circuit 5j is connected to the base of the transistor Q1 and the base of the transistor Q2, and an output side is connected to the reference node Ng.

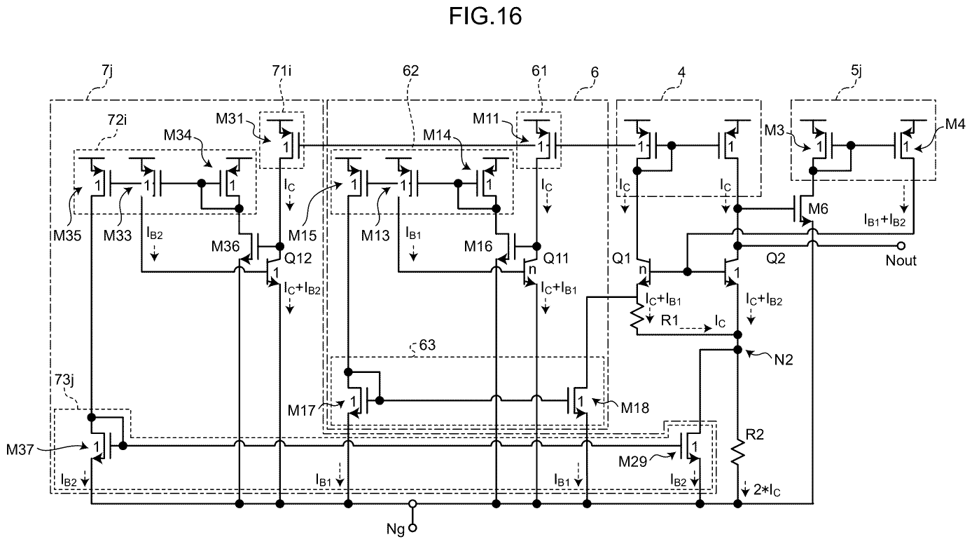

As illustrated in FIG. 16, the current mirror circuit 5j includes a transistor M3 and a transistor M4. FIG. 16 is a circuit diagram illustrating a detailed configuration of a constant voltage generation circuit 1j according to the third embodiment. The transistor M3 and the transistor M4 are connected in current mirror connection to each other. In a case where the transistors Q1 and Q2 are NPN type bipolar transistors and the transistors M3 and M4 are P type field effect transistors, the transistor M3 has a source connected to the power supply node Nvdd, a drain connected to the base of the transistor Q1 and the base of the transistor Q2, and a gate connected to a gate of the transistor M4. The transistor M4 has a source connected to the power supply node Nvdd, a drain connected to the compensation circuit 6i, and the gate connected to the gate of the transistor M3 and the gate of the transistor M4.

The size of the transistor M3 and the size of the transistor M4 are substantially equal. Accordingly, a mirror ratio is approximately 1.

The current mirror circuit 5 receives a current I_{B1}+I_{B2} obtained by summing the base current I_{B1} of the transistor Q1 and the base current I_{B2} of the transistor Q2, on the input side, copies the current I_{B1}+I_{B2} to the output side at a mirror ratio of approximately 1, and outputs the current I_{B1}+I_{B2} from the output side to the reference node Ng via the transistor M6.

Note that the transistor M6 has the gate connected to the drain of the transistor M2 and the source connected to the reference node Ng, and can function as an inverting amplifier.

A loop including the drain of the transistor M6→the drain of the transistor M5→the gate of the transistor M5→the gate of the transistor M3→the drain of the transistor M3→the base of the transistor Q2→the collector of the transistor Q2→the gate of the transistor M6→the drain of the transistor M6 functions as a feedback loop. For example, a voltage corresponding to the current Ic from the load circuit 4 is applied to the gate of the transistor M6, and accordingly, a drain current flowing through the transistor M6 is copied from the drain of the transistor M5 to the drain of the transistor M3 at a mirror ratio of approximately 1. The copied current flows into the base of the transistor Q1 and the base of the transistor Q2, but since the load circuit 4 supplies the current Ic to each of the transistor Q1 and the transistor Q2, a feedback is provided so that the drain current flowing through the transistor M6 becomes I_{B1}+I_{B2}. This point is similar to the first embodiment.

The compensation circuit 7j is connected between the power supply node Nvdd, the node N2, and the reference node Ng. The compensation circuit 7j generates a current I_{B2} corresponding to the base current I_{B2} of the transistor Q2, and extracts the current I_{B2} from the node N2.

As illustrated in FIG. 16, the compensation circuit 7j includes a load circuit 71i, a replica transistor Q12, a current mirror circuit 72i, and a current mirror circuit 73j.

The load circuit 71i is connected between the power supply node Nvdd and the replica transistor Q12. In a case where the replica transistor Q12 is an NPN type bipolar transistor, the load circuit 71i is connected between the power supply node Nvdd and a collector of the replica transistor Q12.

The load circuit 71i includes a transistor M31. The transistor M31 is connected between the power supply node Nvdd and the replica transistor Q12. In a case where the replica transistor Q12 is an NPN type bipolar transistor, the transistor M31 is connected between the power supply node Nvdd and the collector of the replica transistor Q12.

The replica transistor Q12 is connected between the load circuit 71i, the current mirror circuit 72i, and the reference node Ng. The replica transistor Q12 may be an NPN type bipolar transistor. The replica transistor Q12 has the collector connected to the load circuit 71i, an emitter connected to the reference node Ng, and a base connected to the current mirror circuit 72i.

The replica transistor Q12 is provided as a replica of the transistor Q2. A size of the replica transistor Q12 is substantially equal to the size of the transistor Q2. As a result, a current I_{B2} corresponding to the base current I_{B2} of the transistor Q2 flows through the base of the replica transistor Q12.

The current mirror circuit 72i is connected between the power supply node Nvdd and the replica transistor Q12 and the current mirror circuit 73j. An input side of the current mirror circuit 72i is connected to the base of the replica transistor Q12, and an output side is connected to the current mirror circuit 73j.

The current mirror circuit 72i includes a transistor M33, a transistor M34, and a transistor M35. The transistor M33, the transistor M34, and the transistor M35 are connected in current mirror connection to each other. In a case where the replica transistor Q12 is an NPN type bipolar transistor and the transistors M33, M34, and M35 are P type field effect transistors, the transistor M33 has a source connected to the power supply node Nvdd, a drain connected to the base of the replica transistor Q12, and a gate connected to a gate of the transistor M34 and a gate of the transistor M35. The transistor M34 has a source connected to the power supply node Nvdd, and the gate and a drain connected to the gate of the transistor M33, the gate of the transistor M35, and the drain of the transistor M36. The transistor M35 has a source connected to the power supply node Nvdd, a drain connected to the current mirror circuit 73j, and the gate connected to the gate of the transistor M33 and the gate of the transistor M34.

A size of the transistor M33, a size of the transistor M34, and a size of the transistor M35 are substantially equal. Accordingly, a mirror ratio is approximately 1.

The current mirror circuit 72i receives the base current I_{B2} of the replica transistor Q12 on the input side, copies the current I_{B2} to the output side at a mirror ratio of approximately 1, and supplies the current I_{B2} from the output side to the current mirror circuit 73j.

Note that the transistor M36 has the gate connected to the drain of the transistor M31 and the source connected to the reference node Ng, and can function as an inverting amplifier.

A loop including the drain of the transistor M36 →the drain of the transistor M34→the gate of the transistor M34→the gate of the transistor M33→the drain of the transistor M33→the base of the replica transistor Q12→the collector of the replica transistor Q12→the gate of the transistor M36→the drain of the transistor M36 functions as a feedback loop. For example, a voltage corresponding to the current Ic from the load circuit 71i is applied to the gate of the transistor M36, and accordingly, a drain current flowing through the transistor M36 is copied from the drain of the transistor M34 to the drain of the transistor M33 at a mirror ratio of approximately 1. The copied current flows into the base of the replica transistor Q12, but since the load circuit 71i supplies the current Ic, a feedback is provided so that the drain current flowing through the transistor M36 becomes I_{B2}.

An input side of the current mirror circuit 73j is connected to the output side of the current mirror circuit 72i, and an output side is connected to the resistance element R2 parallelly with respect to the node N2.

The current mirror circuit 73j includes a transistor M37 and a transistor M29. The transistor M37 and the transistor M29 are connected in current mirror connection to each other. In a case where the transistors M37 and M29 are N type field effect transistors, the transistor M37 has a source connected to the reference node Ng, and a gate and a drain connected to a gate of the transistor M29. The transistor M29 has a source connected to the reference node Ng, a drain connected to the node N2, and the gate connected to the gate of the transistor M37.

The size of the transistor M37 and the size of the transistor M29 are substantially equal to each other. Accordingly, a mirror ratio is approximately 1.

The current mirror circuit 73j receives the current I_{B2} on an input side, copies the current I_{B2} to an output side at a mirror ratio of approximately 1, and causes the current I_{B2} to flow on the output side. As a result, the current mirror circuit 73j extracts the base current I_{B2} from the node N2.

Note that the transistor M16 has the gate connected to the drain of the transistor M11 and the source connected to the reference node Ng, and can function as an inverting amplifier.

A loop including the drain of the transistor M16 →the drain of the transistor M14→the gate of the transistor M14→the gate of the transistor M13→the drain of the transistor M13→the base of the replica transistor Q11→the collector of the replica transistor Q11→the gate of the transistor M16→the drain of the transistor M16 functions as a feedback loop. For example, a voltage corresponding to the current Ic from the load circuit 61 is applied to the gate of the transistor M16, and accordingly, a drain current flowing through the transistor M16 is copied from the drain of the transistor M14 to the drain of the transistor M13 at a mirror ratio of approximately 1. The copied current flows into the base of the replica transistor Q11, but since the load circuit 61 supplies the current Ic, a feedback is provided so that the drain current flowing through the transistor M16 becomes I_{B1}. This point is similar to the first embodiment.

As described above, in the third embodiment, in the constant voltage generation circuit 1j of the semiconductor integrated circuit 100j, the compensation circuit 6 generates the current I_{B1} corresponding to the base current of the transistor Q1 and extracts the current I_{B1} from the node N1. The compensation circuit 7j generates a current I_{B2} corresponding to the base current of the transistor Q2 and extracts the current I_{B2} from the node N2. As a result, while suppressing an influence of the temperature dependence of the base currents of the transistors Q1 and Q2, the influence of the temperature dependence of the base-emitter voltages of the transistors Q1 and Q2 that can change with a negative increasing function with respect to the temperature can be reduced by the temperature dependence of the voltage across the terminals of the resistance element R2 that can change with a positive increasing function with respect to temperature. As a result, the voltage between the collectors of the transistors Q1 and Q2 and the reference node Ng can be maintained substantially constant with respect to the fluctuation of the environmental temperature, and the constant voltage Vbgr output from the output node Nout can be maintained substantially constant.

In addition, in the third embodiment, in the constant voltage generation circuit 1j of the semiconductor integrated circuit 100j, an operation in which the compensation circuit 6 extracts the current I_{B1} corresponding to the base current of Q1 and an operation in which the compensation circuit 7j extracts the current I_{B2} corresponding to the base current of the transistor Q2 are performed. As a result, while suppressing the influence of the difference between the base currents I_{B1} and I_{B2} according to the difference in the sizes of the transistors Q1 and Q2, it is possible to reduce the influence of the temperature dependence of the base-emitter voltages of the transistors Q1 and Q2, which can change with a negative increasing function with respect to the temperature, by the temperature dependence of the voltage between both ends of the resistance element R2, which can change with a positive increasing function with respect to the temperature.

Note that, as a first modification of the third embodiment, in a constant voltage generation circuit 201j of a semiconductor integrated circuit 200j, in a case where the transistors Q1 and Q2 are NPN type bipolar transistors, for example, it is possible to devise measures to stably equalize a collector current I_{C} of the transistor Q1 and a collector current I_{C} of the transistor Q2.

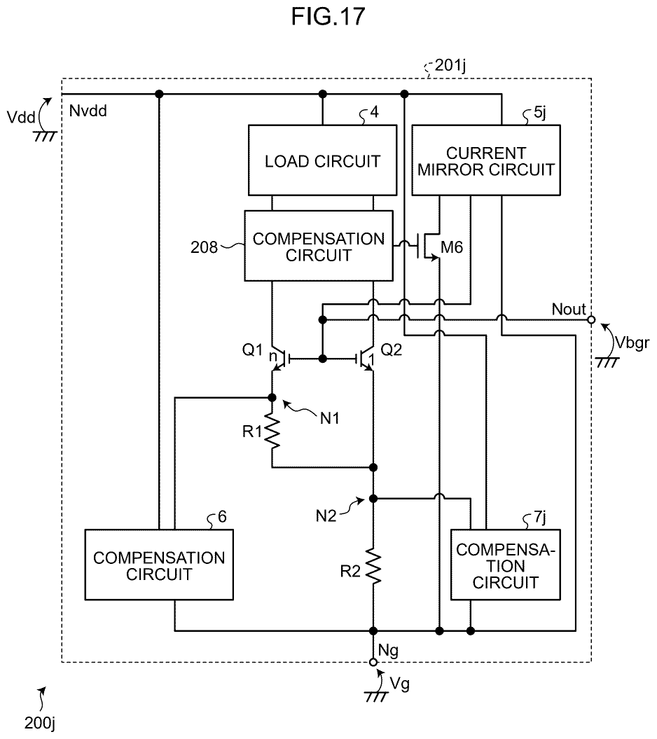

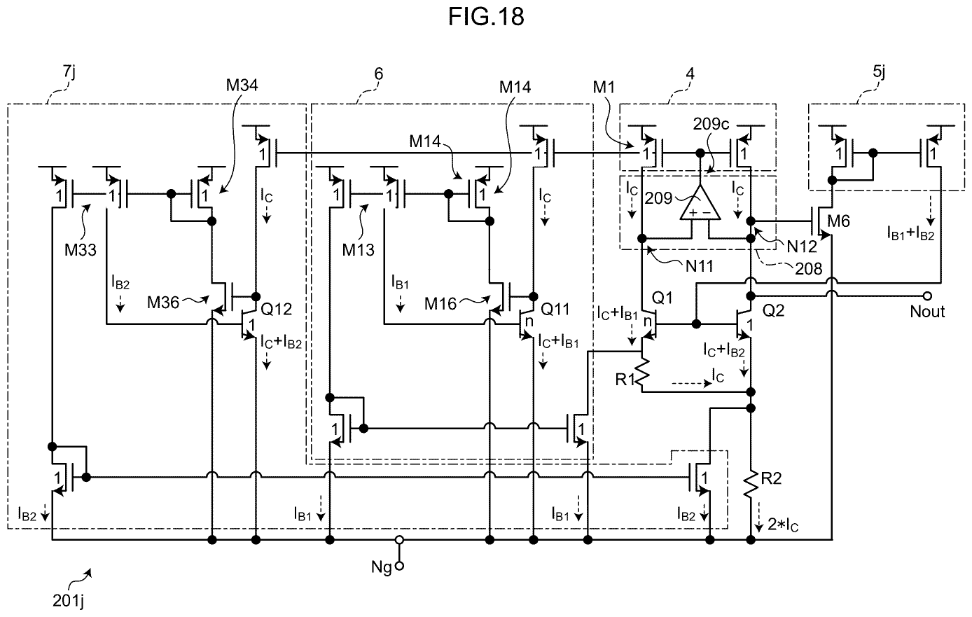

As illustrated in FIGS. 17 and 18, the constant voltage generation circuit 201j of the semiconductor integrated circuit 200j may further include a compensation circuit 208. FIG. 17 is a circuit diagram illustrating a schematic configuration of the constant voltage generation circuit 201j in the first modification of the third embodiment. FIG. 18 is a circuit diagram illustrating a detailed configuration of the constant voltage generation circuit 201j in the first modification of the third embodiment.

The compensation circuit 208 is connected between the load circuit 4 and the transistors Q1 and Q2. The compensation circuit 208 receives a voltage on a side of the transistor Q1 and a voltage on a side of the transistor Q2 from the load circuit 4, and supplies a control signal corresponding to a difference between a current on a side of the transistor Q1 and a current on a side of the transistor Q2 to the load circuit 4.

The compensation circuit 208 includes a differential amplifier 209. The differential amplifier 209 has a non-inverting input terminal 209a connected to a node N11, an inverting input terminal 209b connected to a node N12, and an output terminal 209c connected to the gates of the transistors M1 and M2. The node N11 is connected between the load circuit 4 and the transistor Q1. The node N12 is connected between the load circuit 4 and the transistor Q2.

In a case where the transistors M1 and M2 are P type field effect transistors and the transistors Q1 and Q2 are NPN type bipolar transistors, the node N11 is connected between the drain of the transistor M1 and the collector of the transistor Q1. The node N12 is connected between the drain of the transistor M2 and the collector of the transistor Q2. The transistors M1 and M2 can also be regarded to be connected in current mirror connection via the differential amplifier 209.

The differential amplifier 209 receives a voltage of the node N11 by the non-inverting input terminal 209a and receives a voltage of the node N12 by the inverting input terminal 209b. The differential amplifier 209 outputs a voltage corresponding to a difference between the voltage of the node N11 and the voltage of the node N12 from the output terminal 209c. The differential amplifier 209 may supply the voltage corresponding to the difference between the voltage of the node N11 and the voltage of the node N12 to the load circuit 4 as a control signal.

As a result, the compensation circuit 208 can adjust the load circuit 4 so that the current on the side of the transistor Q1 and the current on the side of the transistor Q2 become equivalent. According to the adjustment result, the compensation circuit 208 supplies the current on the side of the transistor Q1 to the transistor Q1 and supplies the current on the side of the transistor Q2 to the transistor Q2.

Note that the loop including the drain of the transistor M6→the drain of the transistor M5→the gate of the transistor M5→the gate of the transistor M3→the drain of the transistor M3→the base of the transistor Q2 →the collector of the transistor Q2→the gate of the transistor M6→the drain of the transistor M6 functions as a feedback loop. For example, a voltage corresponding to the current Ic from the load circuit 4 is applied to the gate of the transistor M6, and accordingly, a drain current flowing through the transistor M6 is copied from the drain of the transistor M5 to the drain of the transistor M3 at a mirror ratio of approximately 1. The copied current flows into the base of the transistor Q1 and the base of the transistor Q2, but since the load circuit 4 supplies the current Ic to each of the transistor Q1 and the transistor Q2, a feedback is provided so that the drain current flowing through the transistor M6 becomes I_{B1}+I_{B2}. This point is similar to the third embodiment.

In addition, the loop including the drain of the transistor M16→the drain of the transistor M14→the gate of the transistor M14→the gate of the transistor M13→the drain of the transistor M13→the base of the replica transistor Q11→the collector of the replica transistor Q11→the gate of the transistor M16→the drain of the transistor M16 functions as a feedback loop. For example, a voltage corresponding to the current Ic from the load circuit 61 is applied to the gate of the transistor M16, and accordingly, a drain current flowing through the transistor M16 is copied from the drain of the transistor M14 to the drain of the transistor M13 at a mirror ratio of approximately 1. The copied current flows into the base of the replica transistor Q11, but since the load circuit 61 supplies the current Ic, a feedback is provided so that the drain current flowing through the transistor M16 becomes I_{B1}. This point is similar to the third embodiment.

In addition, the loop including the drain of the transistor M36→the drain of the transistor M34→the gate of the transistor M34→the gate of the transistor M33→the drain of the transistor M33→the base of the replica transistor Q12→the collector of the replica transistor Q12→the gate of the transistor M36→the drain of the transistor M36 functions as a feedback loop. For example, a voltage corresponding to the current Ic from the load circuit 71i is applied to the gate of the transistor M36, and accordingly, a drain current flowing through the transistor M36 is copied from the drain of the transistor M34 to the drain of the transistor M33 at a mirror ratio of approximately 1. The copied current flows into the base of the replica transistor Q12, but since the load circuit 71i supplies the current Ic, a feedback is provided so that the drain current flowing through the transistor M36 becomes I_{B2}. This point is similar to the third embodiment.

In this way, the compensation circuit 208 can perform compensation such that the load circuit 4 stably supplies the equivalent currents to the transistor Q1 and the transistor Q2. As a result, the collector current I_{C} of the transistor Q1 and the collector current I_{C} of the transistor Q2 can be stably equalized.

Alternatively, as a second modification of the third embodiment, in a constant voltage generation circuit 301j of a semiconductor integrated circuit 300j, for example, it is possible to devise measures to suppress an influence of a difference between the collector current I_{C} of the transistor Q1 and the collector current I_{C} of the transistor Q2, in a case where the transistors Q1 and Q2 are NPN type bipolar transistors.

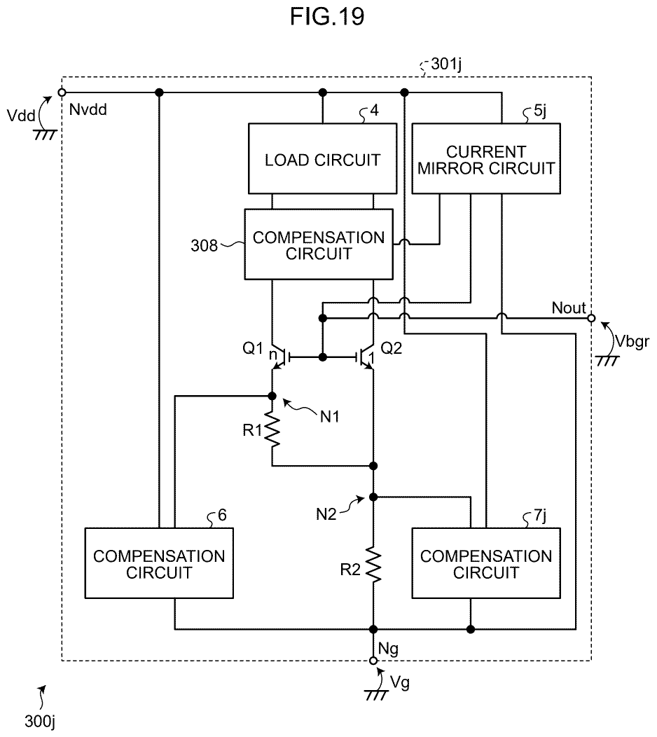

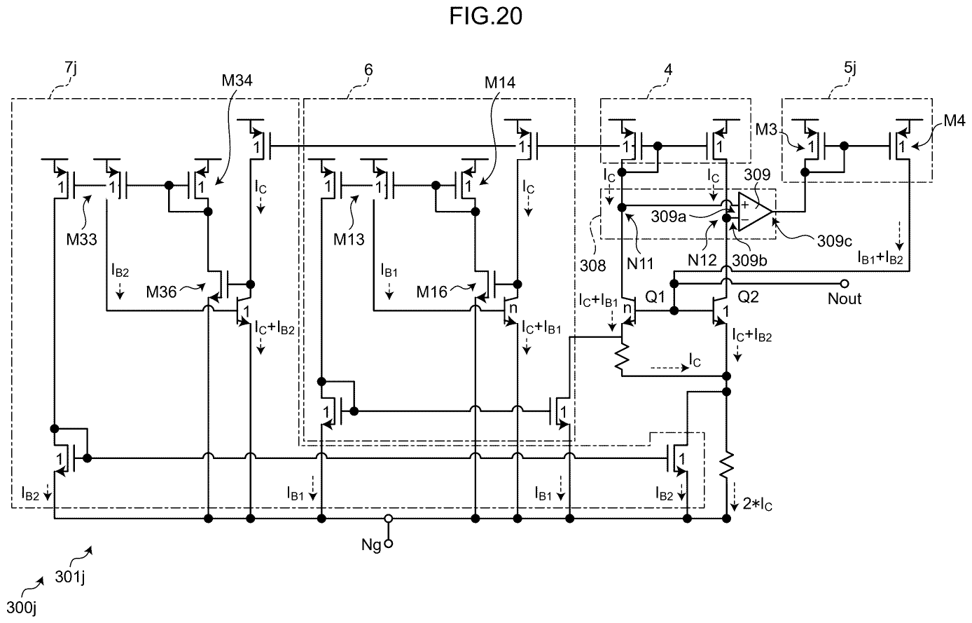

As illustrated in FIGS. 19 and 20, the constant voltage generation circuit 301j of the semiconductor integrated circuit 300j may further include a compensation circuit 308. FIG. 19 is a circuit diagram illustrating a schematic configuration of the constant voltage generation circuit 301j in the second modification of the third embodiment. FIG. 20 is a circuit diagram illustrating a detailed configuration of the constant voltage generation circuit 301j in the second modification of the third embodiment.

The compensation circuit 308 is connected between the load circuit 4 and the current mirror circuit 5, and the transistors Q1 and Q2. The compensation circuit 308 receives a voltage on a side of the transistor Q1 and a voltage on a side of the transistor Q2 from the load circuit 4, and supplies a control signal corresponding to a difference between a current on a side of the transistor Q1 and a current on a side of the transistor Q2 to the current mirror circuit 5.

The compensation circuit 308 includes a differential amplifier 309. The differential amplifier 309 has a non-inverting input terminal 309a connected to the node N11, an inverting input terminal 309b connected to the node N12, and an output terminal 309c connected to the drain of the transistor M5. The node N11 is connected between the load circuit 4 and the transistor Q1. The node N12 is connected between the load circuit 4 and the transistor Q2.

In a case where the transistors M1 and M2 are P type field effect transistors and the transistors Q1 and Q2 are NPN type bipolar transistors, the node N11 is connected between the drain of the transistor M1 and the collector of the transistor Q1. The node N12 is connected between the drain of the transistor M2 and the collector of the transistor Q2.

The differential amplifier 309 receives the voltage of the node N11 by the non-inverting input terminal 309a and receives the voltage of the node N12 by the inverting input terminal 309b. The differential amplifier 309 outputs a voltage corresponding to a difference between the voltage of the node N11 and the voltage of the node N12 from the output terminal 309c. The differential amplifier 309 may supply the voltage corresponding to the difference between the voltage of the node N11 and the voltage of the node N12 to the current mirror circuit 5 as a control signal.

Note that a loop including the output node 309c of the differential amplifier 309→the drain of the transistor M5→the gate of the transistor M5→the gate of the transistor M3→the drain of the transistor M3→the base of the transistor Q2→the collector of the transistor Q2→the input node 309b of the differential amplifier 309 →the output node 309c of the differential amplifier 309 functions as a feedback loop. For example, a voltage corresponding to the current Ic from the load circuit 4 is applied to the input node 309b of the differential amplifier 309, and accordingly, the current flowing through the output node 309c of the differential amplifier 309 is copied from the drain of the transistor M5 to the drain of the transistor M3 at a mirror ratio of approximately 1. The copied current flows into the base of the transistor Q1 and the base of the transistor Q2, but since the load circuit 4 supplies the current Ic to each of the transistor Q1 and the transistor Q2, a feedback is provided so that the current flowing through the output node 309c of the differential amplifier 309 becomes I_{B1}+I_{B2}. This point is similar to the third embodiment.

In addition, the loop including the drain of the transistor M16→the drain of the transistor M14→the gate of the transistor M14→the gate of the transistor M13→the drain of the transistor M13→the base of the replica transistor Q11→the collector of the replica transistor Q11→the gate of the transistor M16→the drain of the transistor M16 functions as a feedback loop. For example, a voltage corresponding to the current Ic from the load circuit 61 is applied to the gate of the transistor M16, and accordingly, a drain current flowing through the transistor M16 is copied from the drain of the transistor M14 to the drain of the transistor M13 at a mirror ratio of approximately 1. The copied current flows into the base of the replica transistor Q11, but since the load circuit 61 supplies the current Ic, a feedback is provided so that the drain current flowing through the transistor M16 becomes I_{B1}. This point is similar to the third embodiment.

In addition, the loop including the drain of the transistor M36→the drain of the transistor M34→the gate of the transistor M34→the gate of the transistor M33→the drain of the transistor M33→the base of the replica transistor Q12→the collector of the replica transistor Q12→the gate of the transistor M36→the drain of the transistor M36 functions as a feedback loop. For example, a voltage corresponding to the current Ic from the load circuit 71i is applied to the gate of the transistor M36, and accordingly, a drain current flowing through the transistor M36 is copied from the drain of the transistor M34 to the drain of the transistor M33 at a mirror ratio of approximately 1. The copied current flows into the base of the replica transistor Q12, but since the load circuit 71i supplies the current Ic, a feedback is provided so that the drain current flowing through the transistor M36 becomes I_{B2}. This point is similar to the third embodiment.

As a result, the current mirror circuit 5 copies a correction current corresponding to the difference between the collector current on the side of the transistor Q1 and the collector current on the side of the transistor Q2 to the input side at a mirror ratio of approximately 1, and supplies the correction current from the input side to the transistors Q1 and Q2.

In this way, in the compensation circuit 308, the current mirror circuit 5 causes the correction current corresponding to the difference between the collector current on the side of the transistor Q1 and the collector current on the side of the transistor Q2 to flow to the input side of the current mirror circuit 5. As a result, the current I_{B1}+I_{B2} flowing on the input side of the current mirror circuit 5 may be corrected, and it is possible to suppress the influence of the difference between the collector current I_{C} of the transistor Q1 and the collector current I_{C} of the transistor Q2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor integrated circuit comprising:
a first transistor having a base connected to an output node;
a second transistor having a base connected to the output node, the second transistor being different in size from the first transistor;
a first resistance element connected between an emitter of the first transistor and an emitter of the second transistor;
a second resistance element connected between the emitter of the second transistor and a reference node;
a first compensation circuit that extracts a first current from a first node between the emitter of the first transistor and the first resistance element, the first current being equivalent to a base current of the first transistor; and
a second compensation circuit that extracts a second current from a second node between the emitter of the second transistor and the second resistance element, the second current being equivalent to a base current of the second transistor.

2. The semiconductor integrated circuit according to claim 1, further comprising:
a first current mirror circuit whose input side is connected to the base of the first transistor and the base of the second transistor, wherein
the second compensation circuit is connected to an output side of the first current mirror circuit, and
the first compensation circuit further extracts the first current from a third node between the first current mirror circuit and the second compensation circuit.

3. The semiconductor integrated circuit according to claim 1, wherein
the first compensation circuit generates the first current and extracts the first current from the first node, and
the second compensation circuit obtains a total current of the first current and the second current, obtains the second current by the first current being extracted from the total current, and extracts the second current from the second node.

4. The semiconductor integrated circuit according to claim 1, further comprising:
a first current mirror circuit whose input side is connected to the base of the first transistor and the base of the second transistor, wherein
the first compensation circuit is connected to an output side of the first current mirror circuit, and
the second compensation circuit further extracts the first current from a fourth node between the first current mirror circuit and the first compensation circuit.

5. The semiconductor integrated circuit according to claim 1, wherein
the second compensation circuit generates the second current and extracts the second current from the second node, and
the first compensation circuit obtains a total current of the first current and the second current, obtains the first current by the second current being extracted from the total current, and extracts the first current from the first node.

6. The semiconductor integrated circuit according to claim 1, wherein
the first compensation circuit generates the first current and extracts the first current from the first node, and
the second compensation circuit generates the second current and extracts the second current from the second node.

7. The semiconductor integrated circuit according to claim 2, wherein
the first compensation circuit includes:
a first replica transistor having a size equivalent to a size of the first transistor;
a second current mirror circuit whose input side is connected to a base of the first replica transistor; and
a third current mirror circuit whose input side is connected to an output side of the second current mirror circuit, and whose output side is connected to the first resistance element parallelly with respect to a fifth node between the emitter of the first transistor and the reference node, and
the second compensation circuit includes:
a fourth current mirror circuit whose input side is connected to the output side of the first current mirror circuit, and whose output side is connected to the second resistance element parallelly with respect to the second node.

8. The semiconductor integrated circuit according to claim 3, wherein
the first compensation circuit includes:
a first replica transistor having a size equivalent to a size of the first transistor;
a second current mirror circuit whose input side is connected to a base of the first replica transistor; and
a third current mirror circuit whose input side is connected to an output side of the second current mirror circuit, and whose output side is connected to the first resistance element parallelly with respect to a fifth node between the emitter of the first transistor and the reference node, and
the second compensation circuit includes:
a fourth current mirror circuit whose input side is connected to the output side of the first current mirror circuit, and whose output side is connected to the second resistance element parallelly with respect to the second node.

9. The semiconductor integrated circuit according to claim 4, wherein
the second compensation circuit includes:
a second replica transistor having a size equivalent to a size of the second transistor;
a sixth current mirror circuit whose input side is connected to a base of the second replica transistor; and
a seventh current mirror circuit whose input side is connected to an output side of the sixth current mirror circuit, and whose output side is connected to the second resistance element parallelly with respect to a sixth node between the emitter of the second transistor and the reference node, and
the first compensation circuit includes:
an eighth current mirror circuit whose input side is connected to the output side of the first current mirror circuit, and whose output side is connected to the first resistance element parallelly with respect to the first node.

10. The semiconductor integrated circuit according to claim 5, wherein
the second compensation circuit includes:
a second replica transistor having a size equivalent to a size of the second transistor;
a sixth current mirror circuit whose input side is connected to a base of the second replica transistor; and
a seventh current mirror circuit whose input side is connected to an output side of the sixth current mirror circuit, and whose output side is connected to the second resistance element parallelly with respect to a sixth node between the emitter of the second transistor and the reference node, and
the first compensation circuit includes:
an eighth current mirror circuit whose input side is connected to the output side of the first current mirror circuit, and whose output side is connected to the first resistance element parallelly with respect to the first node.

11. The semiconductor integrated circuit according to claim 1, wherein
the first compensation circuit includes:
a first replica transistor having a size equivalent to a size of the first transistor;
a second current mirror circuit whose input side is connected to a base of the first replica transistor; and
a third current mirror circuit whose input side is connected to an output side of the second current mirror circuit, and whose output side is connected to the first resistance element parallelly with respect to a fifth node between the emitter of the first transistor and the reference node, and
the second compensation circuit includes:
a second replica transistor having a size equivalent to a size of the second transistor;
a sixth current mirror circuit whose input side is connected to a base of the second replica transistor; and
a seventh current mirror circuit whose input side is connected to an output side of the sixth current mirror circuit, and whose output side is connected to the second resistance element parallelly with respect to a sixth node between the emitter of the second transistor and the reference node.

12. The semiconductor integrated circuit according to claim 6, wherein
the first compensation circuit includes:
a first replica transistor having a size equivalent to a size of the first transistor;
a second current mirror circuit whose input side is connected to a base of the first replica transistor; and
a third current mirror circuit whose input side is connected to an output side of the second current mirror circuit, and whose output side is connected to the first resistance element parallelly with respect to a fifth node between the emitter of the first transistor and the reference node, and
the second compensation circuit includes:
a second replica transistor having a size equivalent to a size of the second transistor;
a sixth current mirror circuit whose input side is connected to a base of the second replica transistor; and
a seventh current mirror circuit whose input side is connected to an output side of the sixth current mirror circuit, and whose output side is connected to the second resistance element parallelly with respect to a sixth node between the emitter of the second transistor and the reference node.

13. The semiconductor integrated circuit according to claim 1, further comprising:
a load circuit that supplies equivalent currents to a collector of the first transistor and a collector of the second transistor.

14. The semiconductor integrated circuit according to claim 13, further comprising:
a differential amplifier circuit including a first input node connected to the collector of the first transistor, a second input node connected to the collector of the second transistor, and an output node connected to a control node of the load circuit.

15. The semiconductor integrated circuit according to claim 2, further comprising:
a differential amplifier circuit including a first input node connected to a collector of the first transistor, a second input node connected to a collector of the second transistor, and an output node connected to the first current mirror circuit.

16. The semiconductor integrated circuit according to claim 1, wherein
a size of the first transistor is n times a size of the second transistor, where n is a number greater than 1.

17. The semiconductor integrated circuit according to claim 2, wherein
a mirror ratio of the first current mirror circuit is approximately 1.

18. The semiconductor integrated circuit according to claim 7, wherein
each of a mirror ratio of the first current mirror circuit, a mirror ratio of the second current mirror circuit, a mirror ratio of the third current mirror circuit, and a mirror ratio of the fourth current mirror circuit is approximately 1.

19. The semiconductor integrated circuit according to claim 1, wherein
a current amplification factor of the first transistor and a current amplification factor of the second transistor respectively have current density dependence and temperature dependence.

20. The semiconductor integrated circuit according to claim 1, wherein
each of a base-emitter voltage of the first transistor and a base-emitter voltage of the second transistor respectively changes with a negative increasing function with respect to temperature, and
a voltage across terminals of the second resistance element changes with a positive increasing function with respect to temperature.
